(19) United States
(12) Patent Application Publication
(10) Pub. No.: US 2016/0292615 A1
(43) Pub. Date: Oct. 6, 2016

(54) DATA DRIVEN RELATIONSHIP ADVISOR APPARATUS AND METHOD

(71) Applicant: SurePeople LLC, Arlington Heights, IL (US)

(72) Inventor: NIKO DRAKOULIS, ARLINGTON HEIGHTS, IL (US)

(21) Appl. No.: 15/090,342

(22) Filed: Apr. 4, 2016

Related U.S. Application Data
(60) Provisional application No. 62/142,780, filed on Apr. 3, 2015.

(51) Int. Cl. G06Q 10/06

(52) U.S. Cl. CPC G06Q 10/06398

(57) ABSTRACT

A data driven relationship advisor apparatus and method generates relationship factors based on an individual's trait assessment. The apparatus and method enable an administrator to compare the traits of two individuals based on different trait assessments for the two individual to illustrate differences and similarities between the two individuals.

### CROSS REFERENCE TO CO-PENDING APPLICATION

This application claims priority benefit to the Apr. 3, 2015 filing date of co-pending US Provisional Patent Application Ser. No. 62/142,780 filed in the name Niko Drakoulis as inventor of a “Data Driven Talent Management and Talent Acquisition Apparatus and Method”, the entire contents of which are incorporated herein in its entirety.

### BACKGROUND

The present data driven relationship advisor apparatus and method relates, in general, to trait assessment tools.

Successful businesses require a motivated team of employees and administrators working toward a common business goal. However, every person has different traits, motivation, intelligence, and other personality characteristics which make team interaction and achievement of business goals a hit or miss prospect at best.

### SUMMARY

The apparatus and method measures an individual's emotional intelligence, relational intelligence and team intelligence by analyzing multiple unique traits based on a plurality of attributes. Assessing these attributes in the company's employees enables the business administrator to better understand their employees' personalities, strengths, growth opportunities and capacities.

In one aspect, the method generates an individual's assessment data by accessing a memory by a computer processor coupled through a network to individual processors, administering an assessment through the individual processors to determine an individual's assessment data and analyzing the assessment data by the computer processor and generating an assessment report to the at least one of individual processors containing relationship factors for at least one of two individuals relating to relationship factors that at least one of the two individuals should recognize when interacting with the other of the two individuals.

The apparatus includes a computer processor assessing accessing an assessment test, at least one individual processor coupled through a network to the computer processor, and a display coupled to the at least one individual processor for displaying the relationship factors.

### BRIEF DESCRIPTION OF THE DRAWING

The various features, advantages and other uses of the present invention will become more apparent by referring to the following detailed description and drawing.

FIG. 1 is a block diagram of the components of the data driven assessment apparatus;

FIGS. 2A and 2B show a flow diagram of the business administrator login procedure for the data driven assessment method.

FIGS. 3A and 3B show a flow diagram of the business dashboard.

FIGS. 4A and 4B show a flow diagram of a business request for PRISM LENS™ assessment.

FIG. 5 is a flow diagram of a business sequence to take a PRISM LENS™ assessment.

FIG. 6 is a flow diagram of an individual sign up procedure for the data driven assessment apparatus and method.

FIGS. 7A and 7B show a flow diagram of the individual login sequence.

FIGS. 8A and 8B show a flow diagram of the individual dashboard of the present apparatus and method.

FIGS. 9A and 9B show a flow diagram of an individual request for a PRISM LENS™ assessment.

FIG. 10 is a flow diagram of the process for an individual to take a PRISM LENS™ assessment.

FIGS. 11A-11I are pictorial representations of sample assessment questions.

FIGS. 12A-12D show a pictorial representation of an assessment report of an individual's primary personality.

FIGS. 13A-13D show a pictorial representation of a personality under pressure assessment results of an individual.

FIGS. 14A-14C show a pictorial representation of processing blueprints assessment results of an individual.

FIGS. 15A-15C show a pictorial representation of motivation assessment results of an individual.

FIGS. 16A and 16B show a pictorial representation of conflict management assessment results of an individual.

FIG. 17 is a pictorial representation of fundamental need assessment results of an individual.

FIGS. 18A and 18B show a pictorial representation of decision making assessment results of an individual.

FIGS. 19A and 19B show a pictorial representation of primary learning style assessment results of an individual.

FIGS. 20A and 20B show a pictorial representation of the combined assessment results depicted in FIGS. 12A-19B.

FIG. 21 is a flow chart depicting the relationship advisor sequence of the present apparatus and method.

FIGS. 22A-22F are examples of a relationship advisor report featuring a comparison of two individuals.

### DETAILED DESCRIPTION

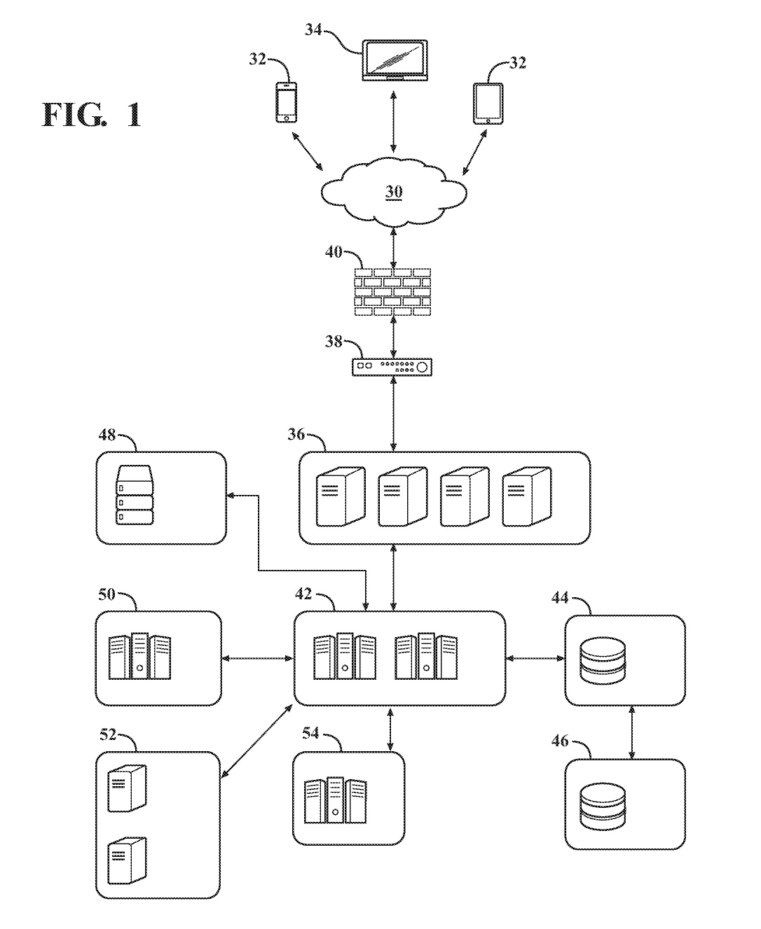

FIG. 1 depicts a cloud-based apparatus using a network, such as the worldwide web 30, for interaction between employers and employee via smartphones 32 and computers 34 to acquire employee assessment information, as well as reporting the results of such information to business management or to the individual.

As shown in FIG. 1, the apparatus, by example, includes a computer processor, which can be in the form of one or more web servers 36 connected to the worldwide web 30 through a load balancer 38 and a firewall 40. The web servers 36 communicate with one or more application servers 42. The application servers 42 communicate with database servers 44 and backup database servers 46, as well as data storage servers 48, a payment gateway server 50, a third party content services server 52 and CMS servers 54 (central management servers).

The present apparatus and method provide assessment-related reports to both business management and employees. The business side of the apparatus and method will first be described.

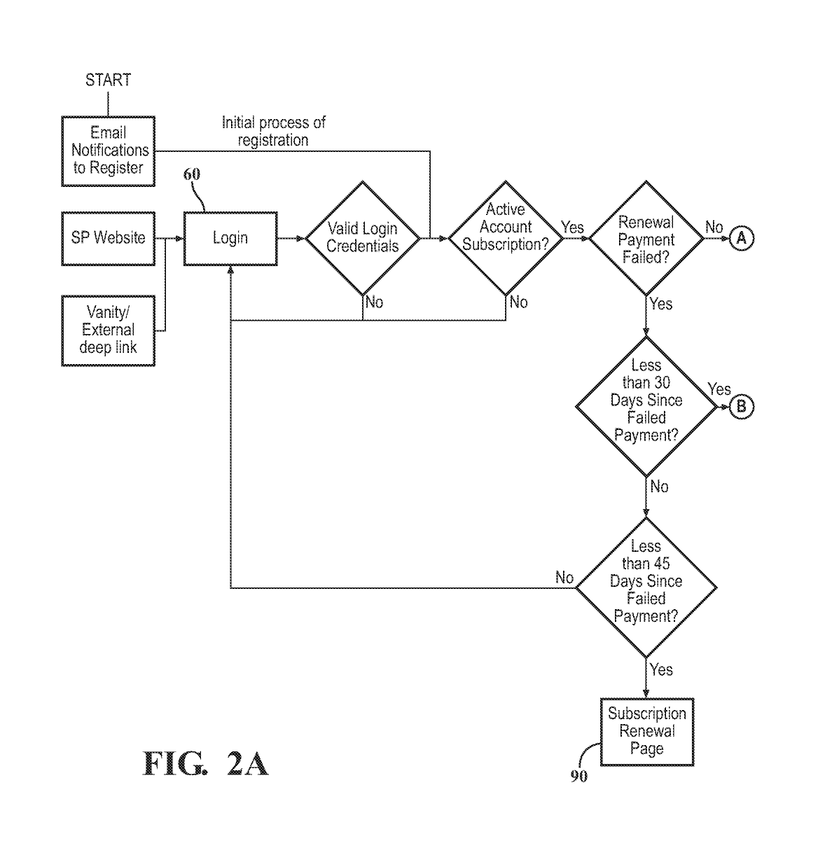

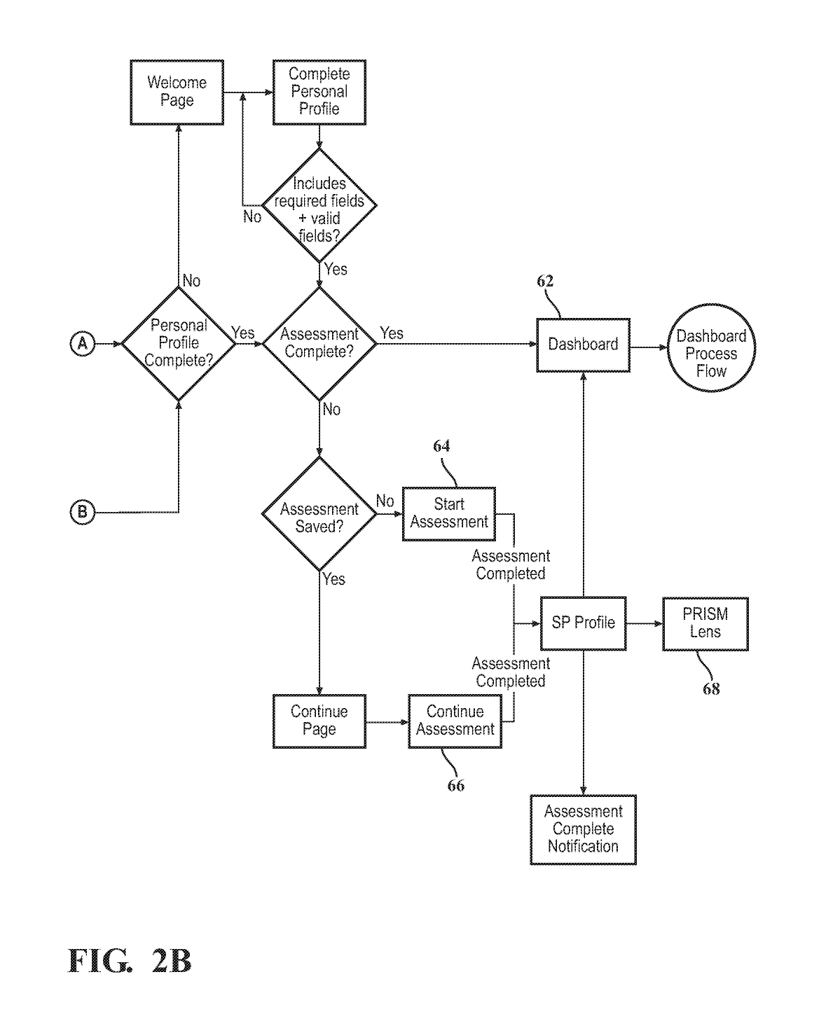

A business administration portion of the apparatus and method is shown in FIGS. 2A-11I and is accessible by at least one or more individual processors, such as a smartphone 32 or a computer 34 at a business site through the worldwide web 30 to the central computer processor system shown in FIG. 1.

As shown in FIGS. 2A and 2B, a business administrator can log-in in step 60 to open or access an assessment account. Such accounts include business profiles, subscription renewal services, etc. A dashboard 62 displayed on a computer monitor at the business site allows access by the business administrator to various parts of the employee assessment apparatus and method, including starting an assessment in step 64, continuing an assessment 66, and using the assessment results to create an employee profile in step 68.

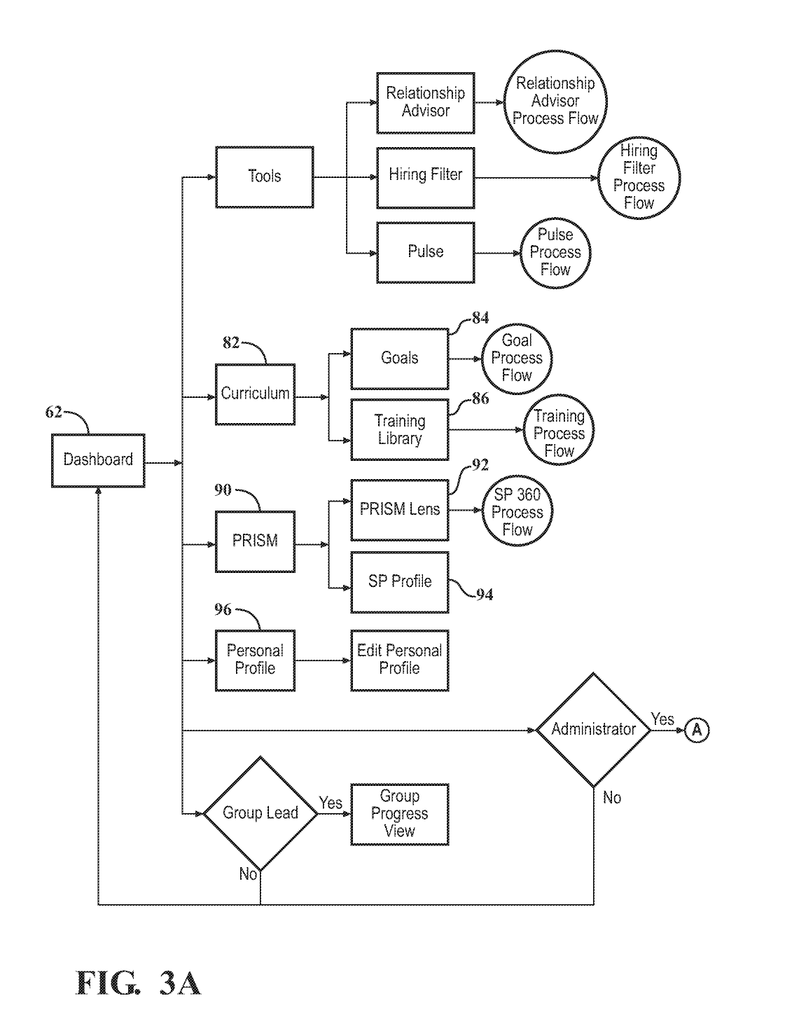

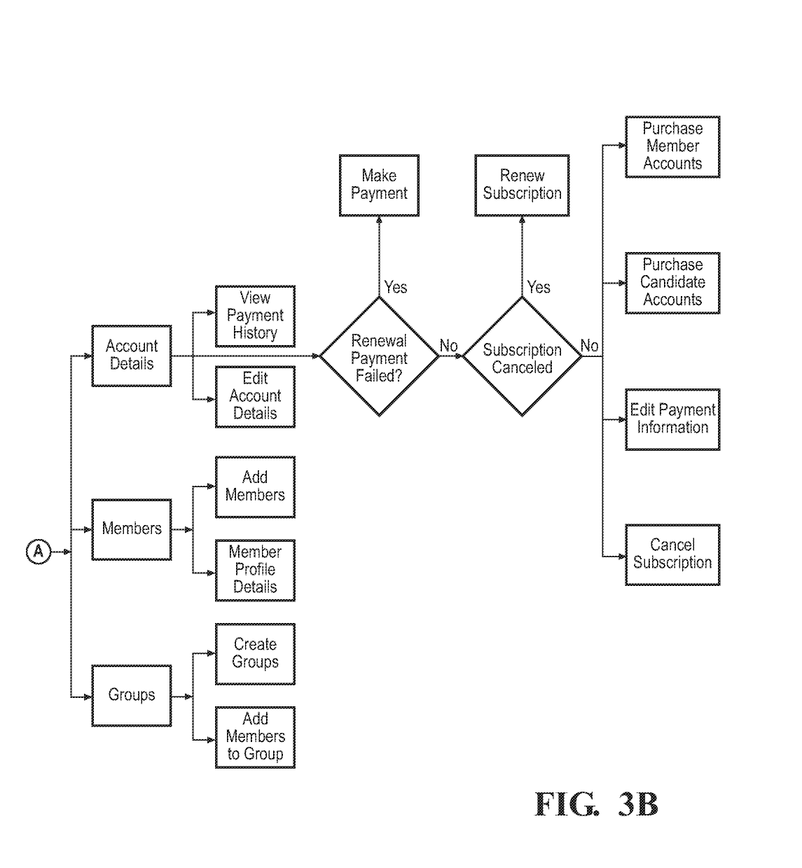

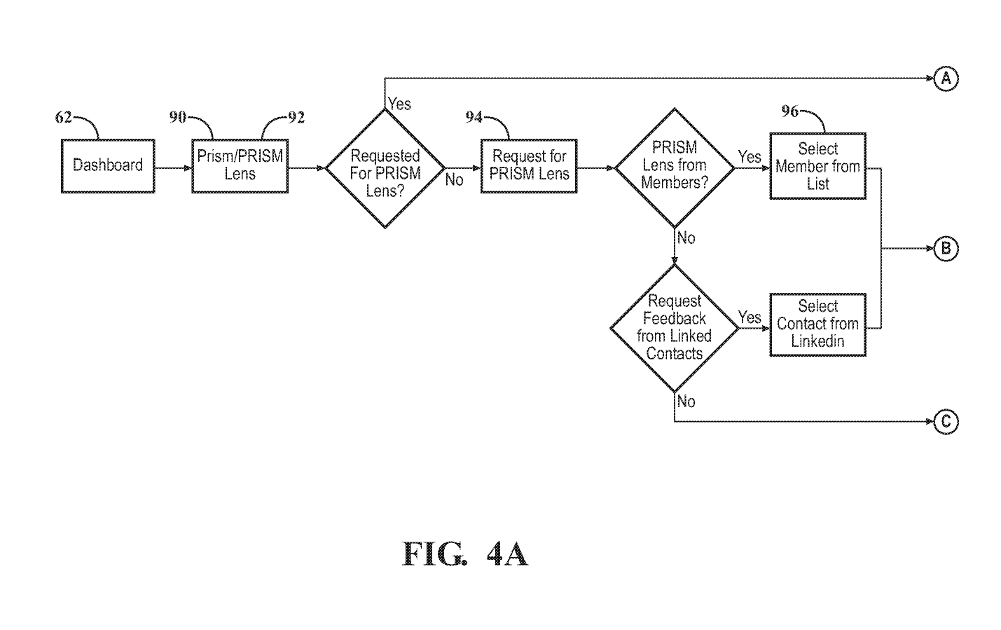

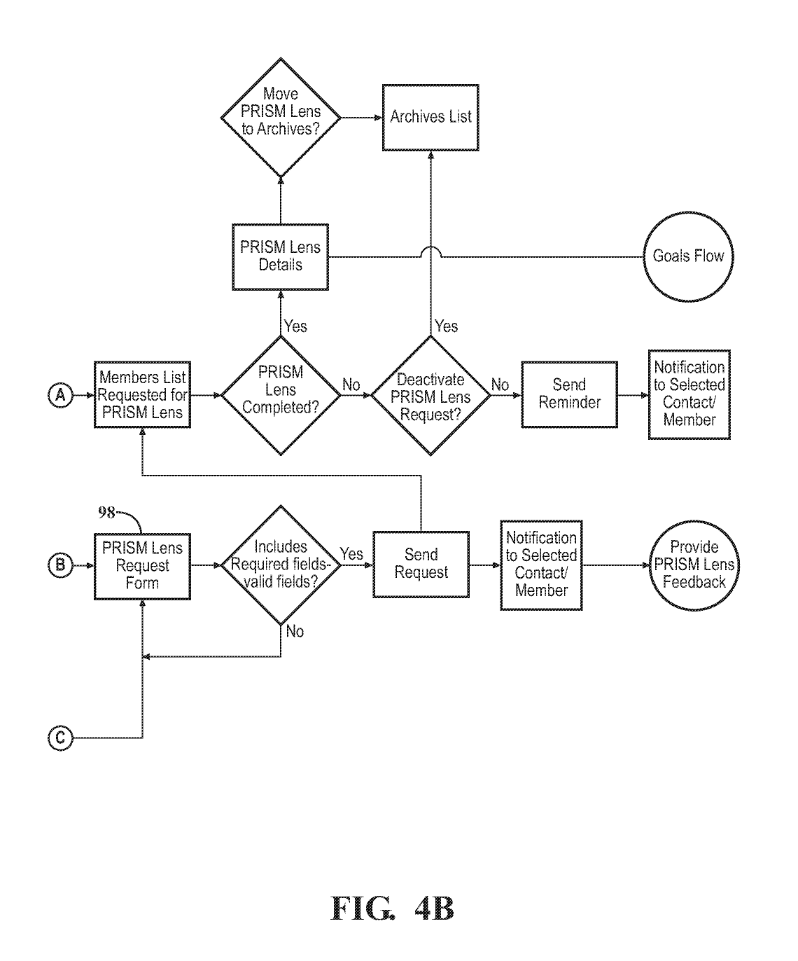

The dashboard 62, shown in FIGS. 3A and 3B, also allows access to various assessment or module features, such as a knowledge center 86. The dashboard 62 allows selection of a PRISM LENS™ module 92 allowing access to assessments 92 by an individual's peers and/or manager, or other individuals see FIG. 4, as well as to employee profiles 94. The dashboard 62 also allows access to a personal profile module 96 allowing the business administrator to edit the personal profile of any employee.

The dashboard 62 also provides additional versatility for the business to make payments as well as for the individual selected by the business or an outside individual to take an assessment 90. As shown in FIGS. 3A and 3B, a business administrator may assess account details 87 and make payments 89 in a number of different ways, such as all at once, periodic, automatically renewable, etc.

The business administrator may also authorize an individual selected by the business administrator to take an assessment test 90 to select, either at the businesses' or the individual's preference, to take all seven assessments of the PRISM™ assessment test 90 at one time, one at a time, in any partial sequence of less than the seven assessment, as well as providing a date deadline for completing all of the of the PRISM™ 90 assessment. In some instances, a business may not require all seven module of the PRISM™ 90 assessment described hereafter, in which case the business may direct an individual to take only selected assessments which are than presented to the individual. In the latter case, the individual may still have the preference to take all or some of the selected assessments at over a one-time preset time period etc.

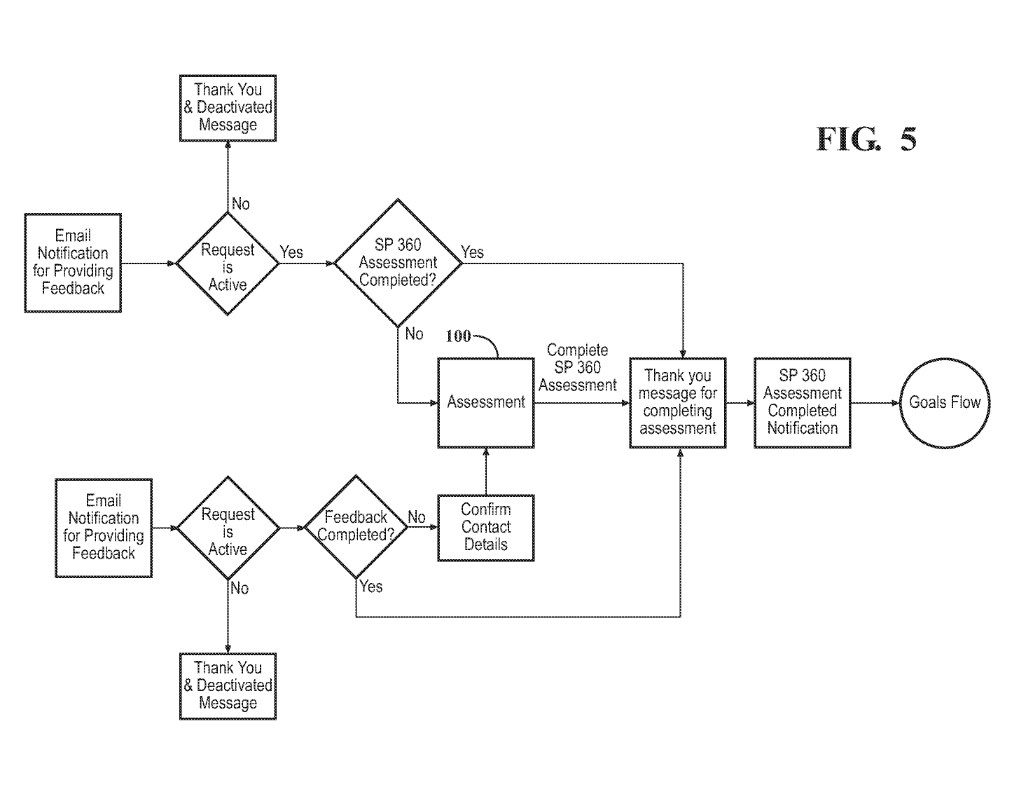

In the business mode, shown in FIGS. 4A, 4B, and 5, an administrator and/or employee may submit a request for an individual, such as an employee or non-employee, to take a PRISM LENS™ assessment 92 on another individual.

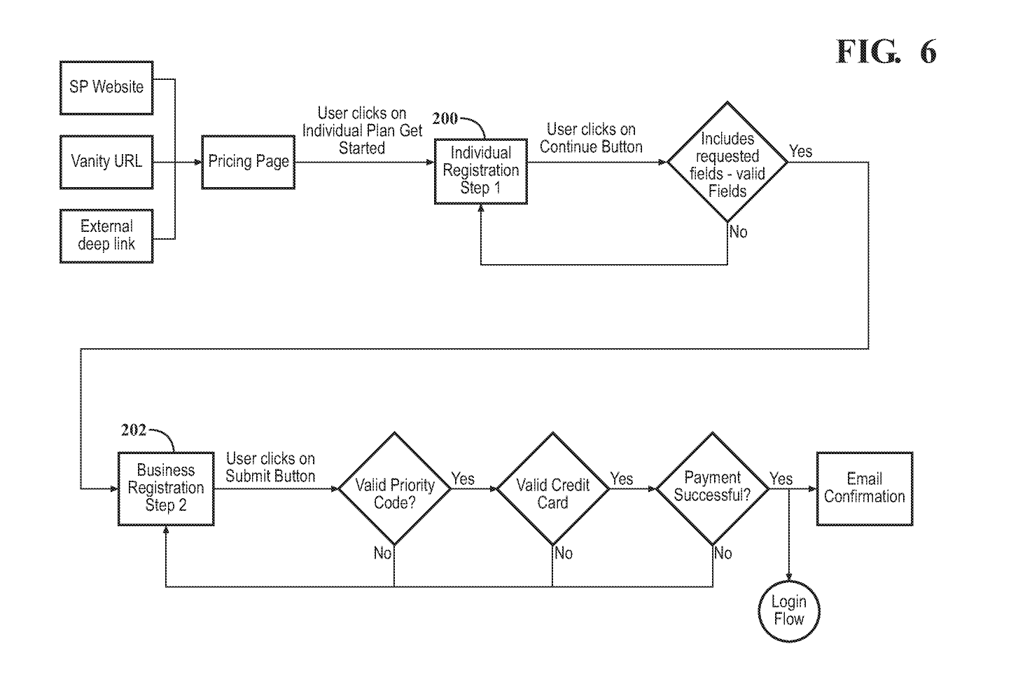

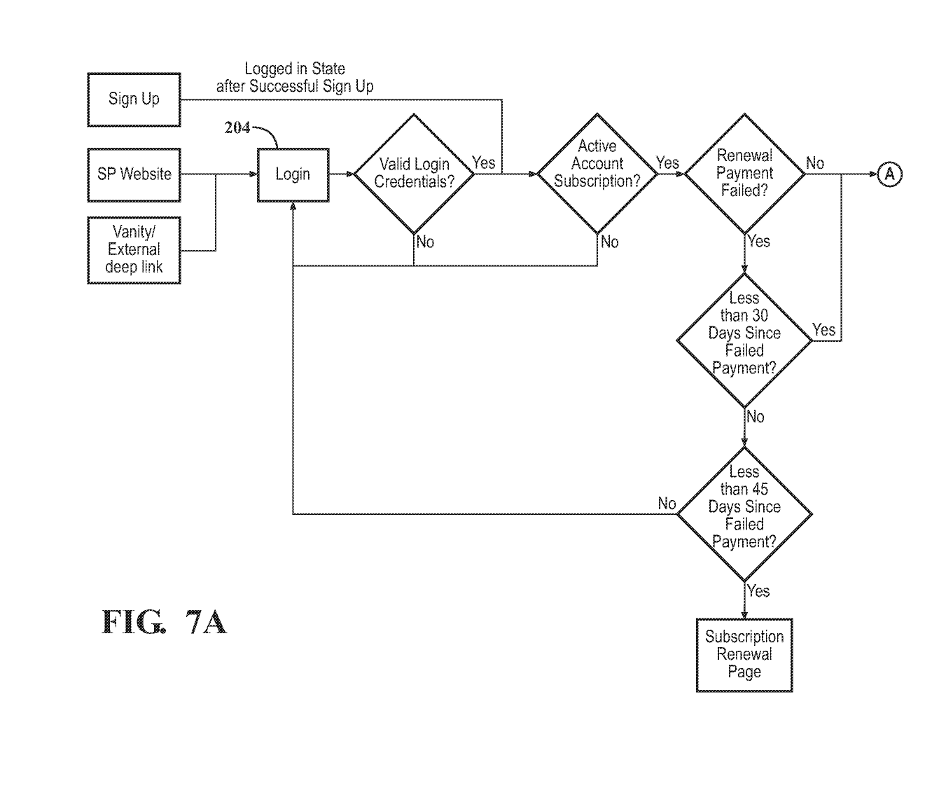

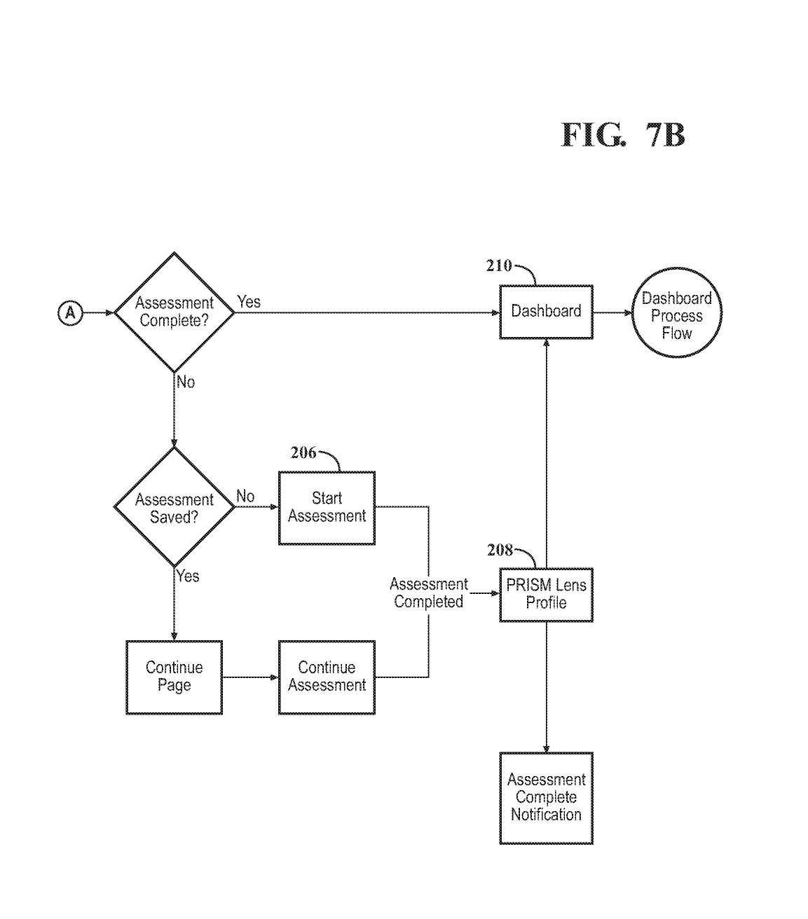

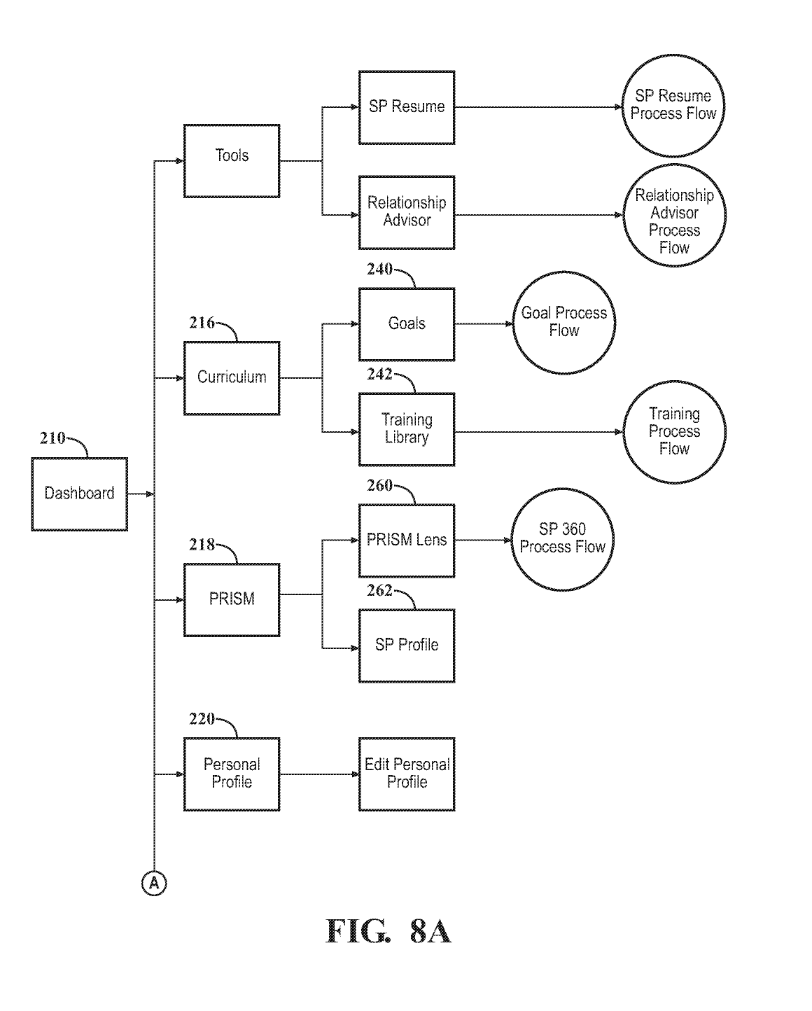

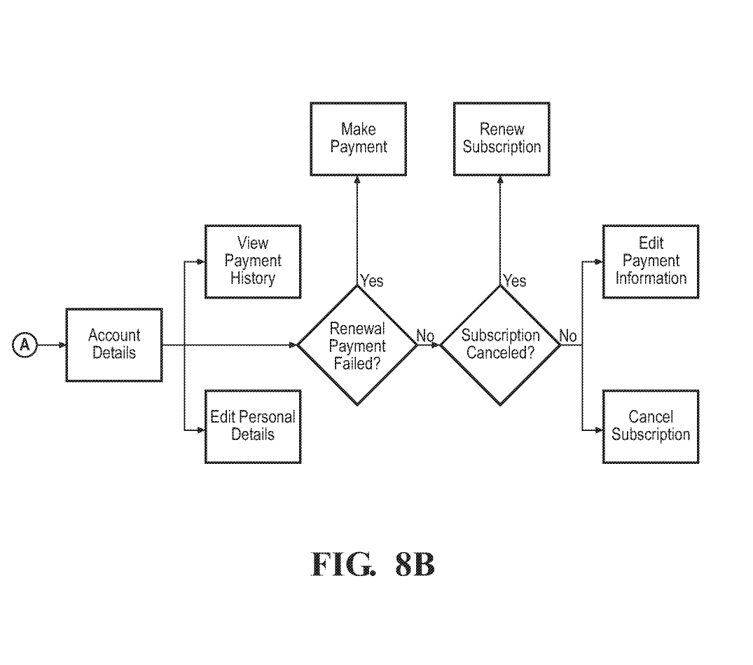

An individual may access the apparatus and method as described hereafter and shown in FIGS. 6-11I. Such individuals may be employees of a particular business who is registered with the apparatus and method, as described above, or totally unrelated to a particular business. An individual, as shown in FIG. 6, can individually register in step 200 or register through a business in step 202. After logging in in step 204 in FIG. 7A, an individual can start and/or continue the assessment 206 to create a 360 degree profile 208 which is input to a dashboard 210 for each individual in FIG. 7B. The dashboard 210 as shown in FIGS. 8A and 8B, allows access to a tools module 212, and a prism module 218.

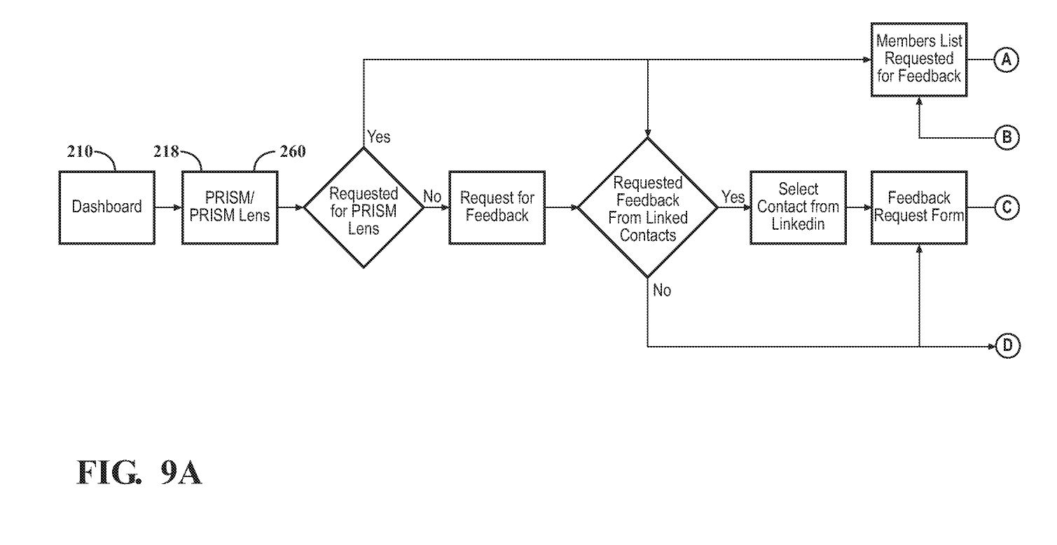

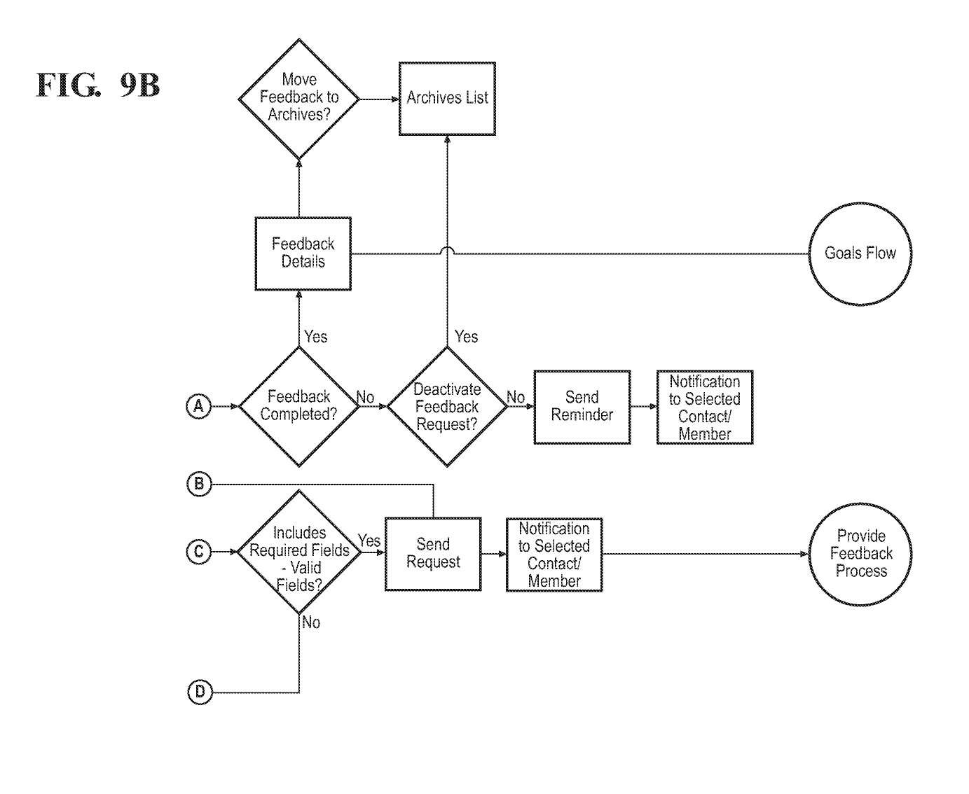

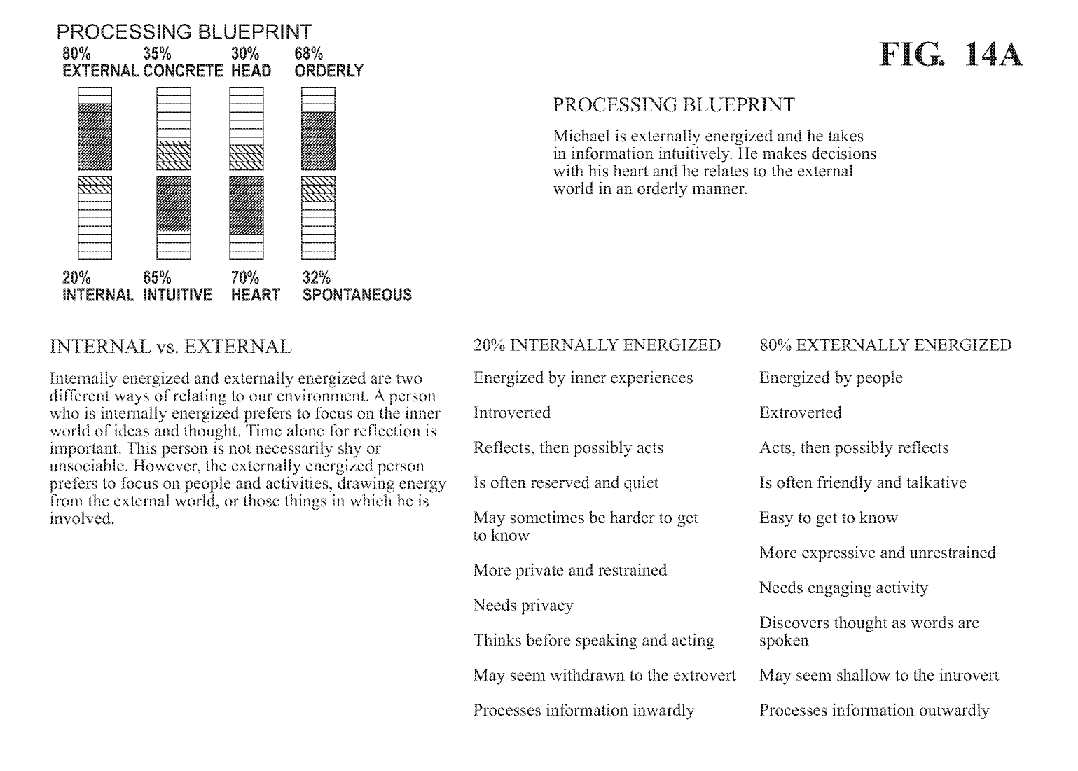

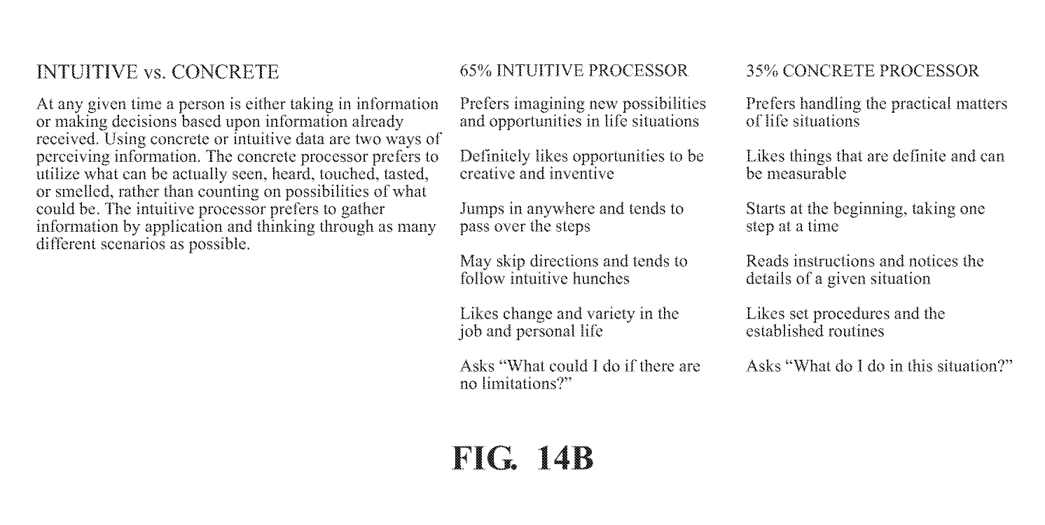

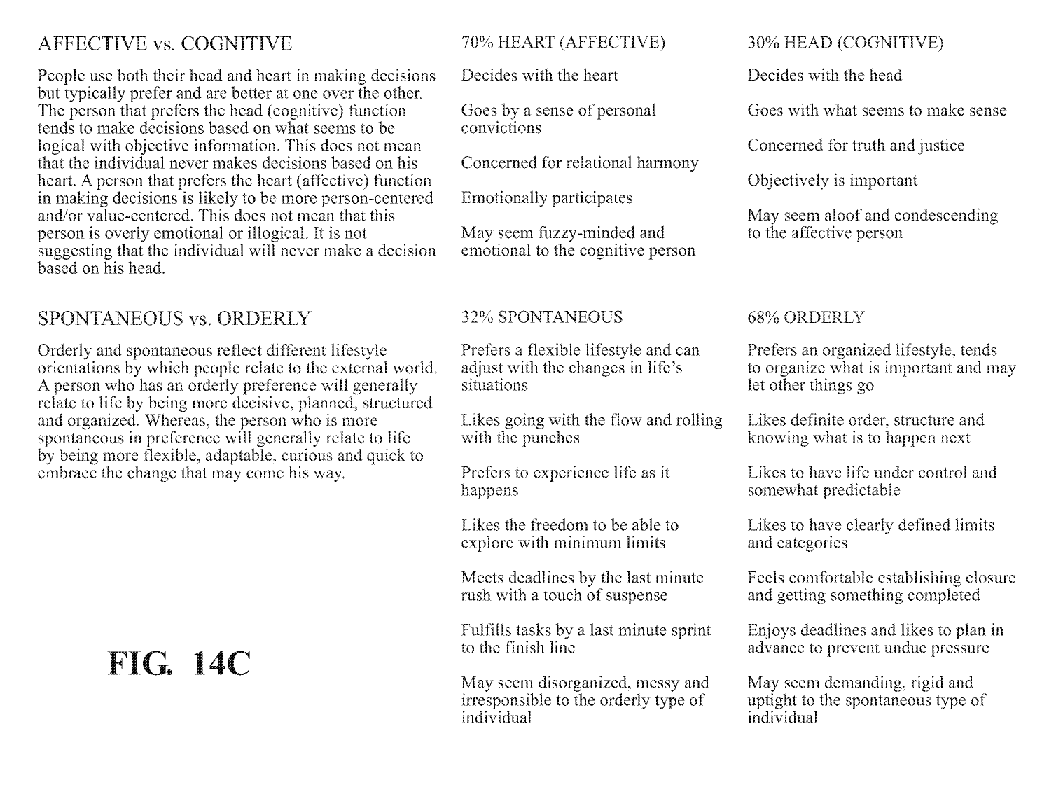

As shown in FIGS. 9A and 9B, an individual, through the PRISM LENS™ module 218, can access the PRISM LENS™ assessment 260 or review the individual's profile 262. As shown in detail in FIGS. 5, 8A, 8B, 9A, and 9B, when the individual selects the PRISM LENS™ assessment 260, the individual can select contacts or members for assessment by the sequence shown in FIGS. 14A-14C and receive feedback and actionable recommendations to improvements on the employees.

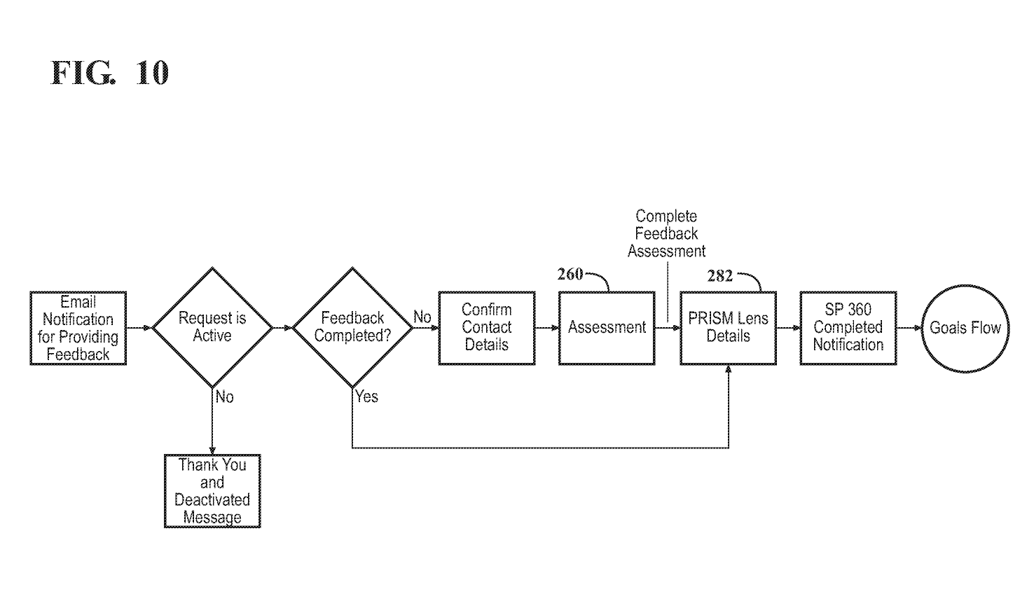

Finally, as shown in FIG. 10, an individual can access and complete the assessment 260 and receive an assessment report 282.

The PRISM LENS™ module 92 is further shown in detail in FIGS. 4A and 4B, when the PRISM™ module 90 and the PRISM LENS™ assessment tool module 92 are accessed through the dashboard 62. The PRISM LENS™ assessment module 92 allows a business administrator to select one or more individuals or employees of the business to provide an assessment of one employee. After receiving a request for the PRISM LENS™ assessment 92 in step 94, the business administrator can select one or more members from a list 96 and then send a request form 98 to the selected members.

The PRISM™ 90 assessment takes large amounts of data and converts the data to make it easy for businesses and employees to see, understand and put into action. The PRISM™ 90 assessment functions to identify multiple attributes including personality profile (primary and under pressure), processing blueprint, motivation, conflict management, fundamental needs, decision making and learning style.

The assessment apparatus and method creates a number of distinct primary employee personality profiles and employee personality profiles under pressure to assist a business administrator in determining whether or not to hire an employee, as well as determine how the employee is interacting with other business or business team members and the fit between employees on a team. Such personality profiles can include, for example:

Scientist Researcher

Navigator

Visionary

Architect

Catalyst

Tough & Tender

Connector

Instructor

Ally

Pragmatist

Strategist

Influencer

Peacemaker

Pioneer

Ambassador

The apparatus and method establishes characteristics for each of the personality profiles describing how an employee having a particular personality thinks, makes decisions, handles tasks and other personal relationships, work environment preferences. Each personality also has a list of work style characteristics, as well as how this particular individual with a specific personality may fit into a particular business team, how the individual is likely to communicate with team members, how the individual is influenced by negative perceptions of or by other team members. Such characteristics also enable a supervisor to best supervise and encourage an individual with a particular personality profiles.

These personality profiles enable a business administrator, when forming a team of employees or hiring a new employee as an addition to an existing team, to best choose the team members or the new employee to fit into the team, and to meet the goals of the team.

These personality types and personality under pressure types are established by the assessment program which asks an individual a series of questions describing workplace scenarios, preferences, motivation, work styles, etc. Based on the answers, the assessment program of the apparatus and method establishes a particular personality type for an individual. The established characteristics associated with that individual's personality can then be established for the business administrator.

This assessment information is valuable to the business administrator when forming a team, determining the efficiency of an established team, or when conferring to hire a new employee and placing that employee in a particular team. This enables the business administrator to achieve the business goals in an efficient manner, as well as advancing the growth of each employee.

A business employee, as well as non-business individuals, who take the PRISM™ 90 assessment, are provided with a custom portrait of their personality, how they operate in a business environment when making decisions, interacting with others, achieving goals, for advancing the individual to meet business-related and/or life goals.

Appendix A depicts a number of different personality profiles used by the present assessment apparatus and method. These personality profiles are examples only as the number of personality profiles used by the apparatus and method can include less than or more than the different personality profiles described in Appendix A.

The personality profiles shown in Appendix A as well as the actual assessment as described hereafter are provided by way of an example as any available assessment program may be employed in the present apparatus and method. The personality characteristics of any individual from any available assessment can be correlated to the sixteen personality profiles and the seven assessments described hereafter.

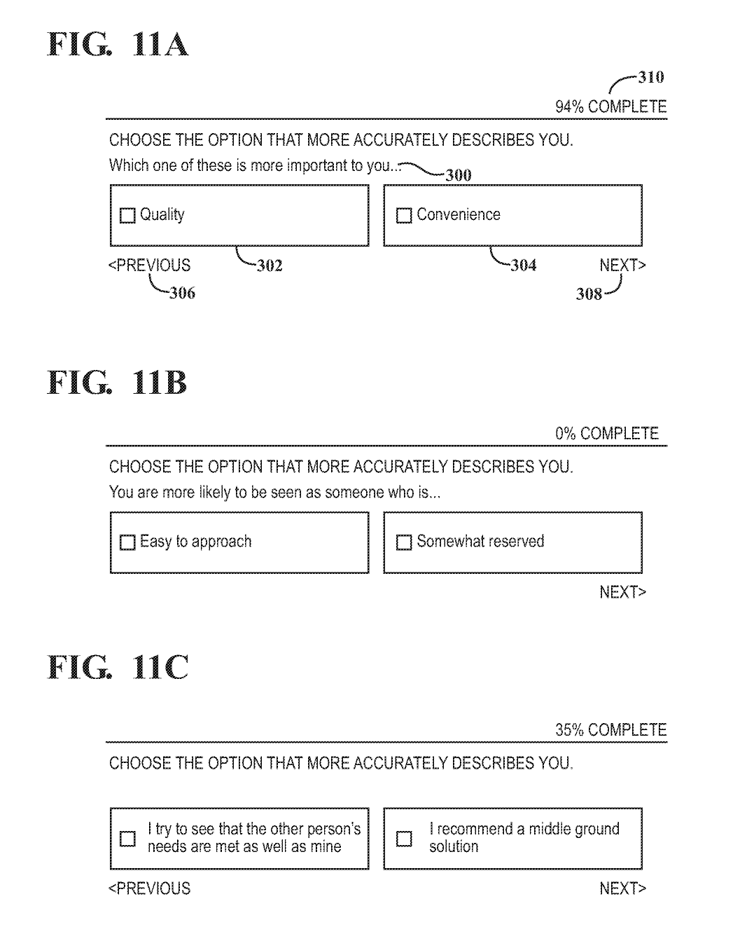

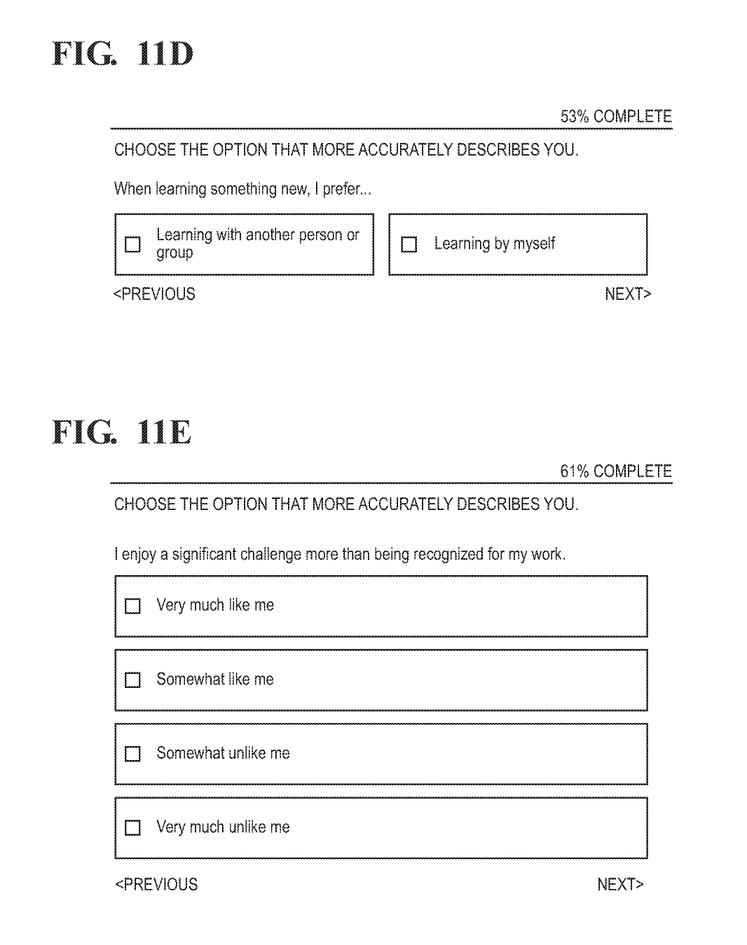

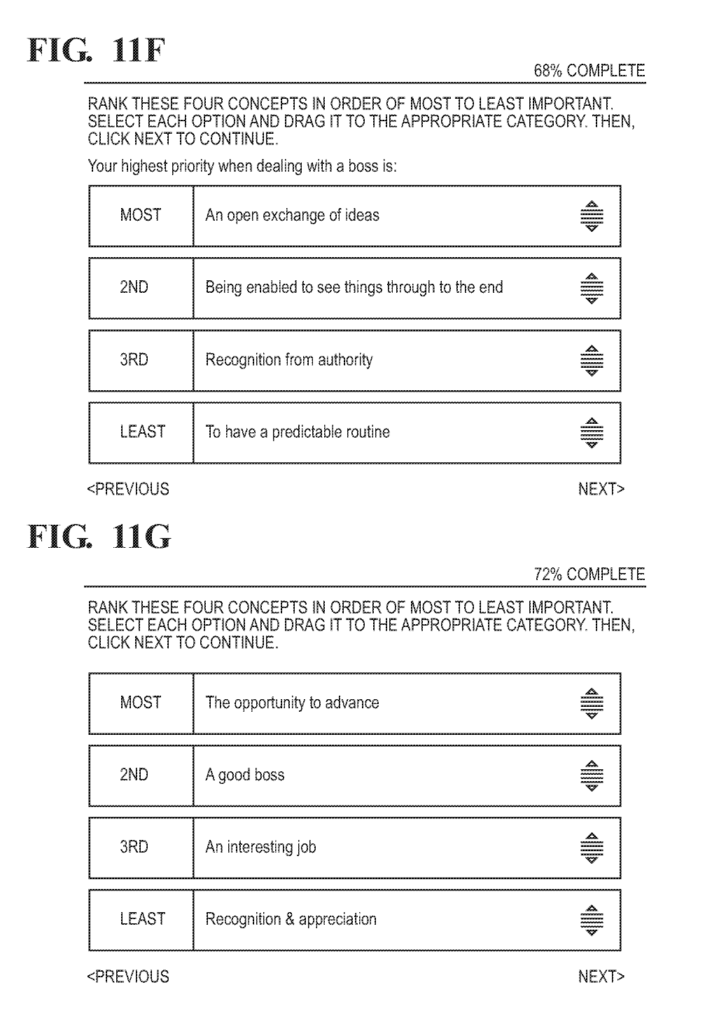

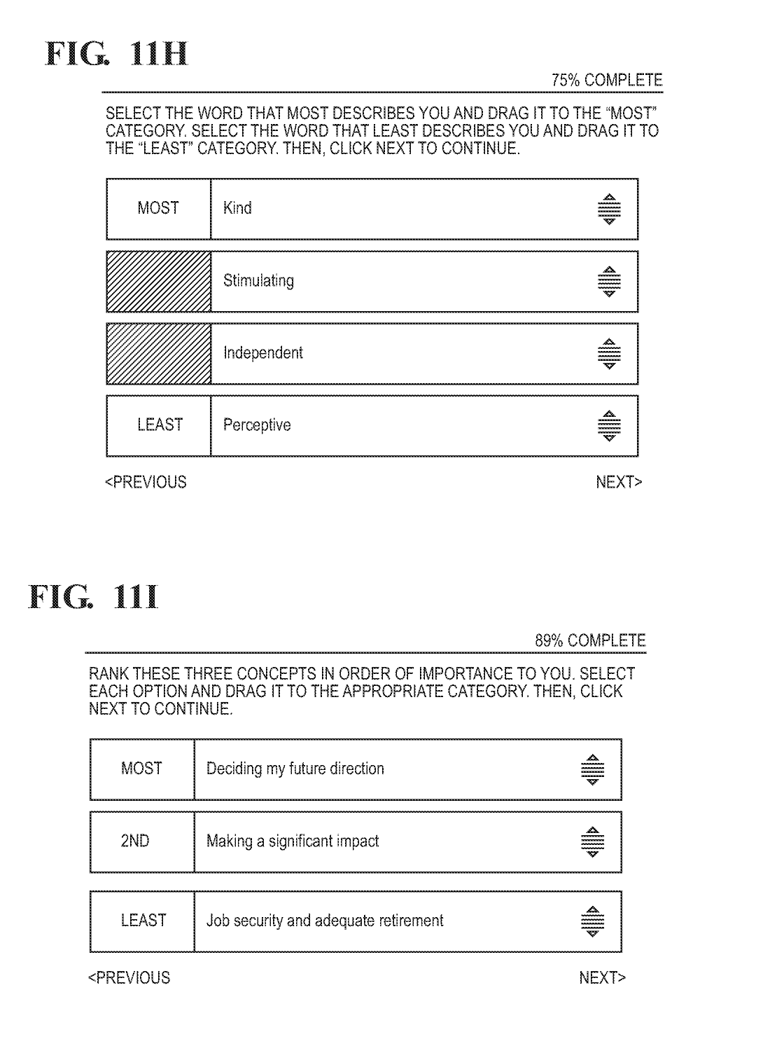

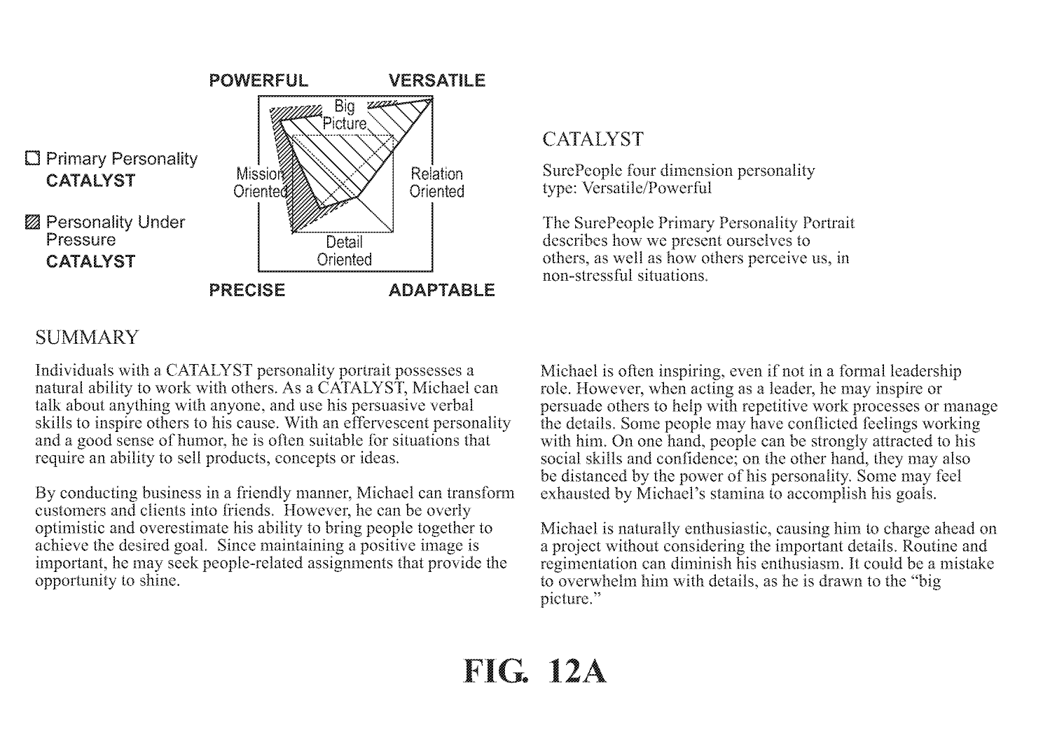

FIGS. 11A-11I depict different forms of assessment questions presented to the individual as part of the PRISM™ 90 assessment. The questions are displayed on a monitor and generally ask an individual to choose the characterization that most generally describes that individual's view of the assessment question. The page displayed on the monitor also enable the individual to easily return to a previous question or to advance to the next question. The display also depicts the percent completion 310 of the entire assessment 90.

The data driven assessment apparatus and method presents the personality and the individual characteristics in easy to read scales, charts and graphs to enable a business administrator or the individual to easily ascertain the individual's personality, decision making tendencies motivation, etc.

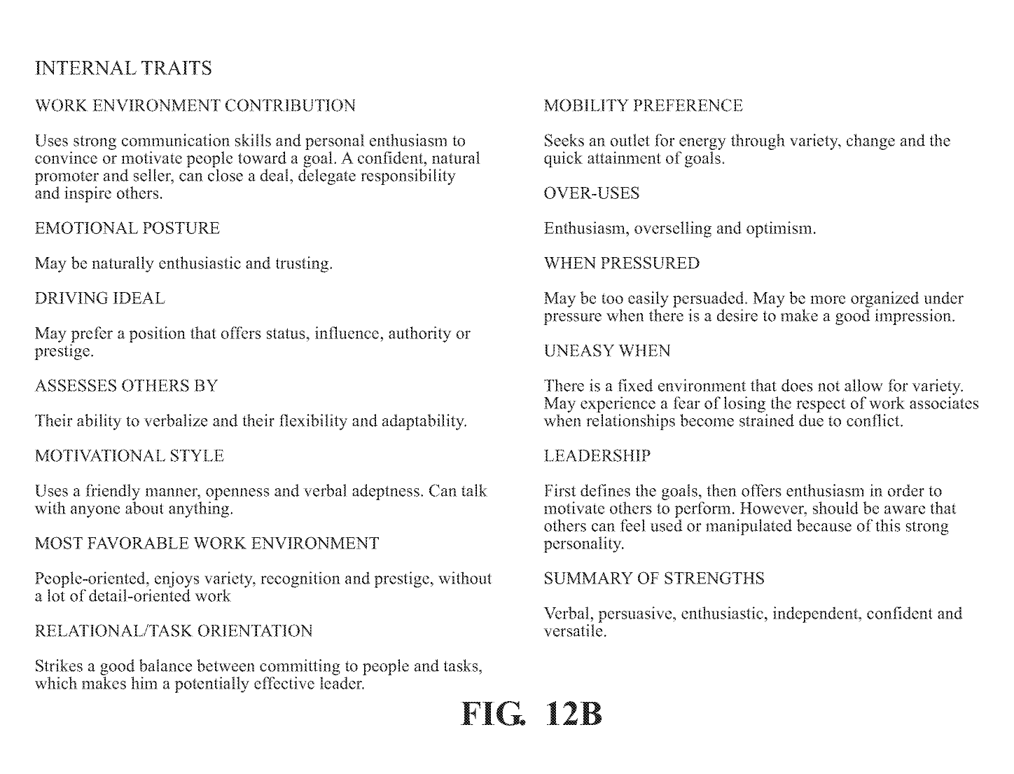

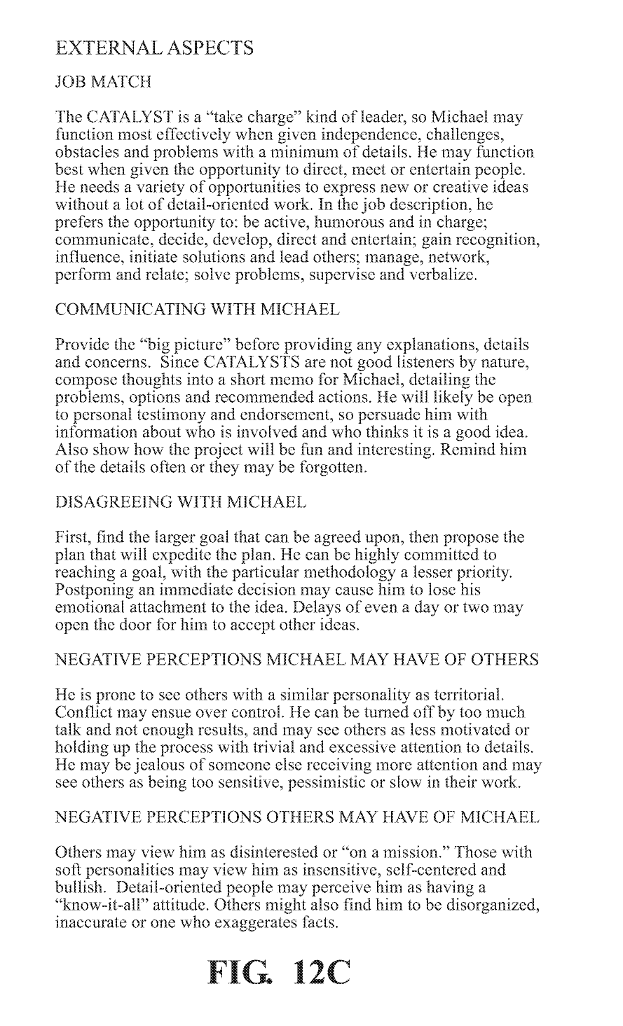

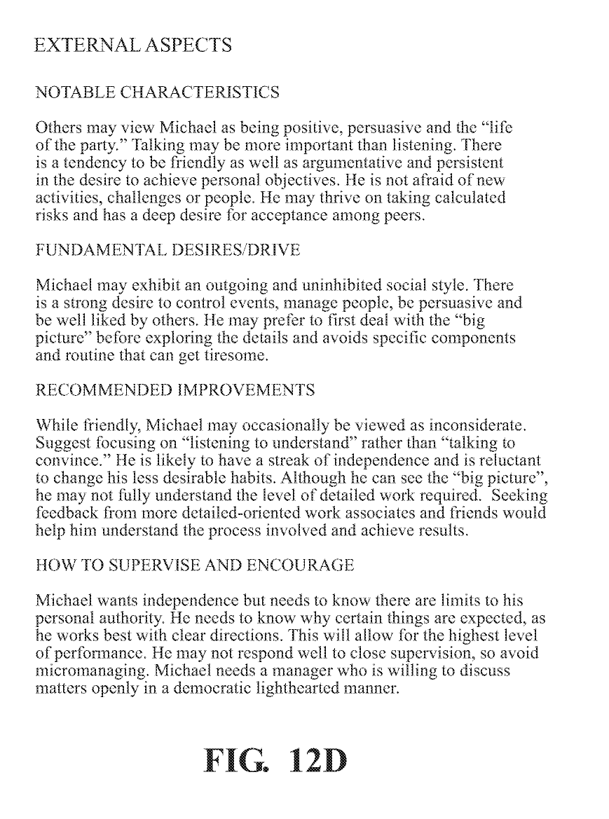

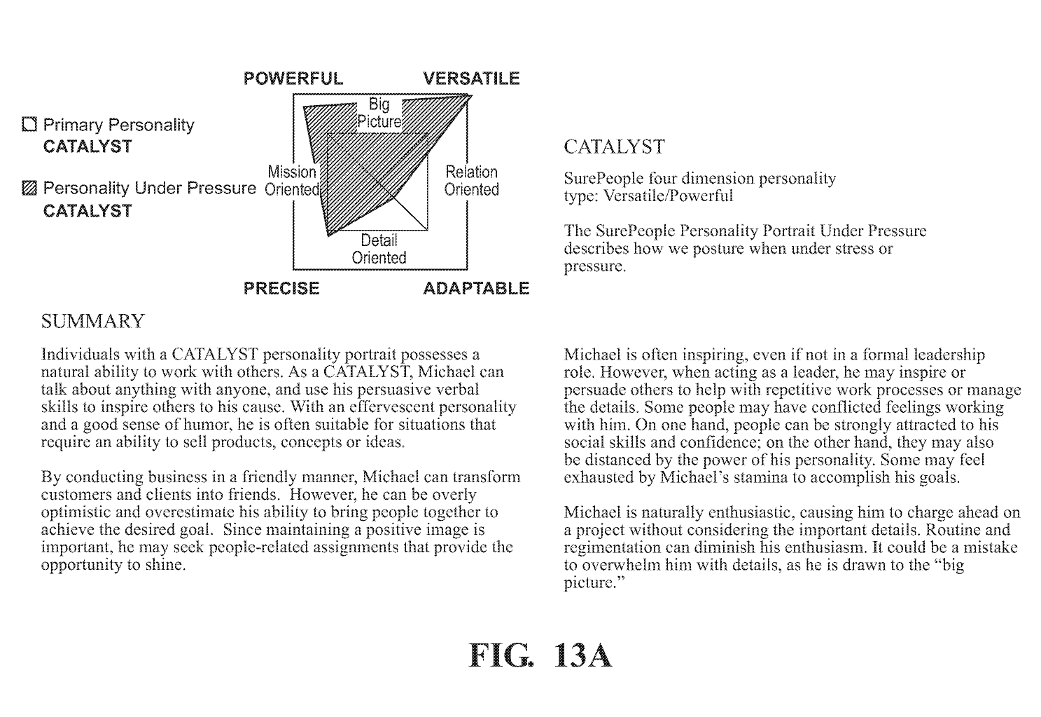

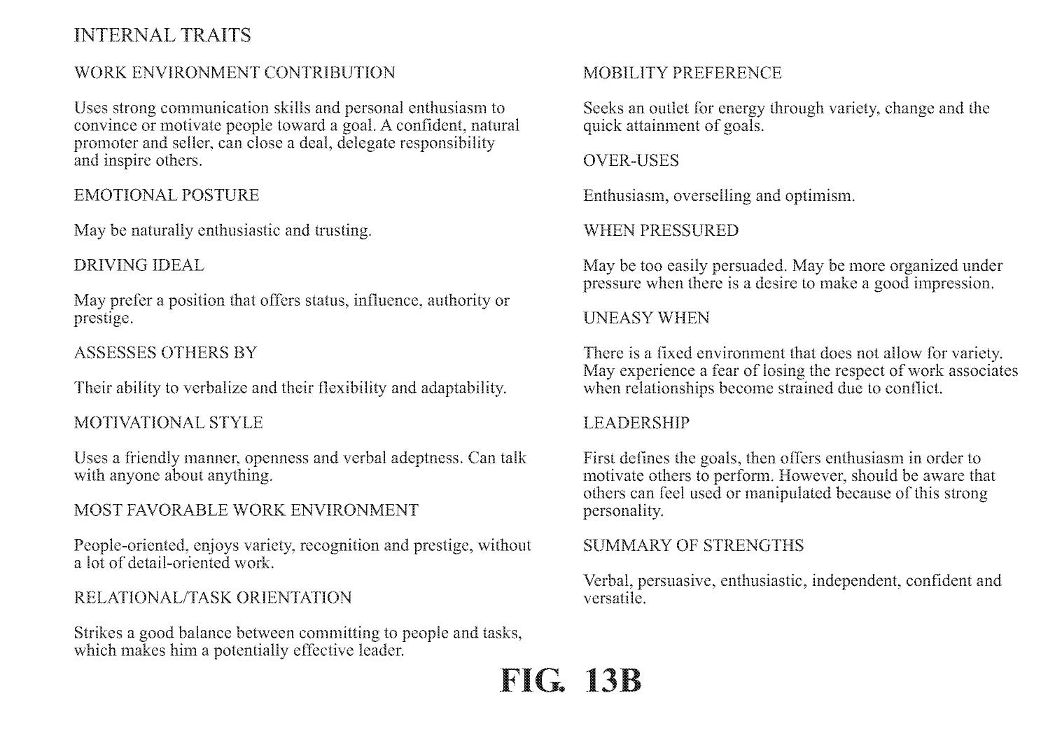

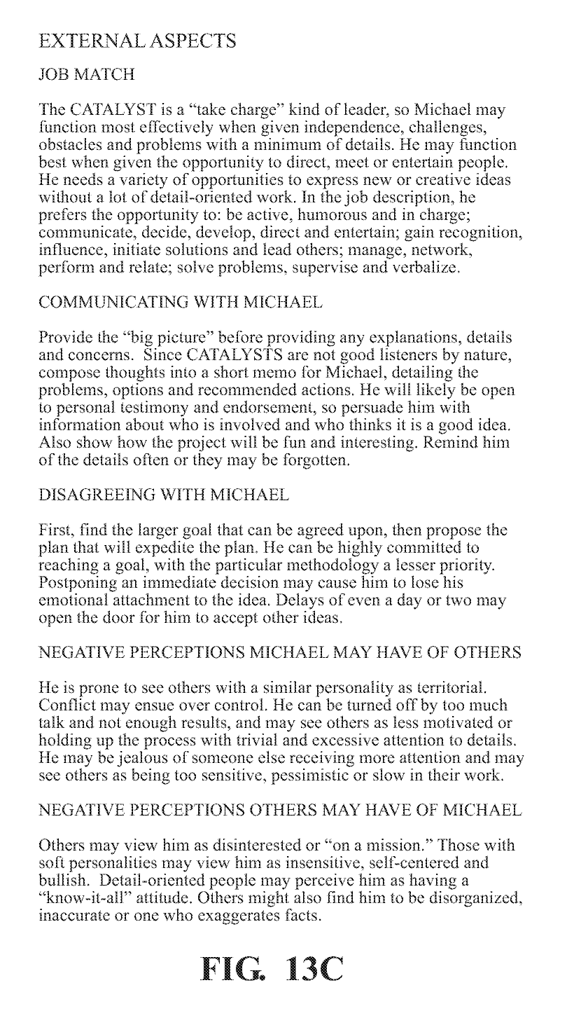

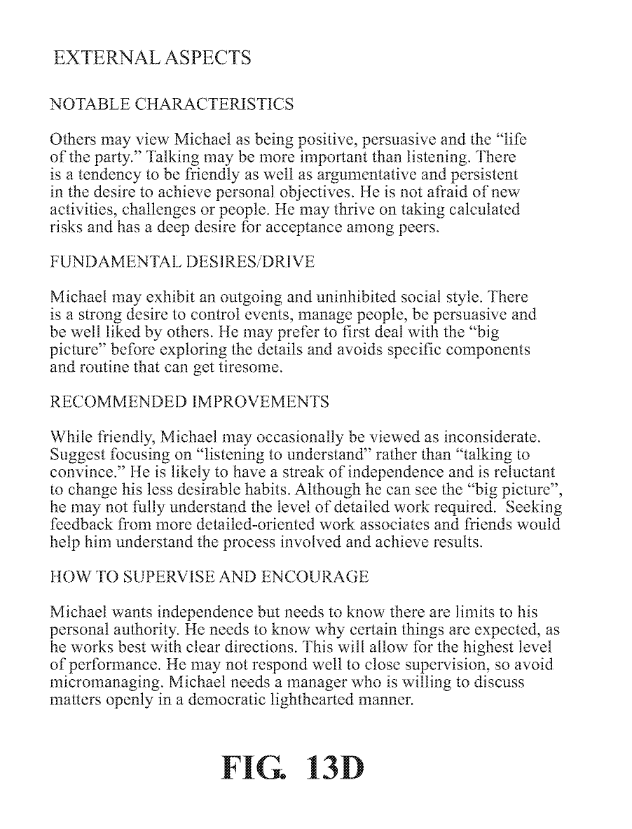

The PRISM™ 90 assessment reveals both primary personality in FIGS. 12A-12D and personality under pressure in FIGS. 13A-13D within a four dimensional scale that measures power, versatility, precision and adaptability. The PRISM™ 90 assessment delivers a comprehensive summary filled with insights and a unique classification for people to see, read, and understand their personality.

Not everyone absorbs information in the same way. After processing information, some people will make decisions more with their head, while others tend to take action with their heart. The processing blueprint feature of PRISM™ 90 assessment shown in FIGS. 14A-14C shows how employees approach people, activities, thoughts, and causes in their lives based on four distinct scales, including:

Internal vs External: How people are energized by outside factors or inner thoughts and concepts.

Intuitive vs Concrete: The way people take in and perceive information.

Head vs Heart: If people tend to make decisions guided more by their thoughts or feelings.

Spontaneous vs Orderly: How people prefer to approach and relate to live.

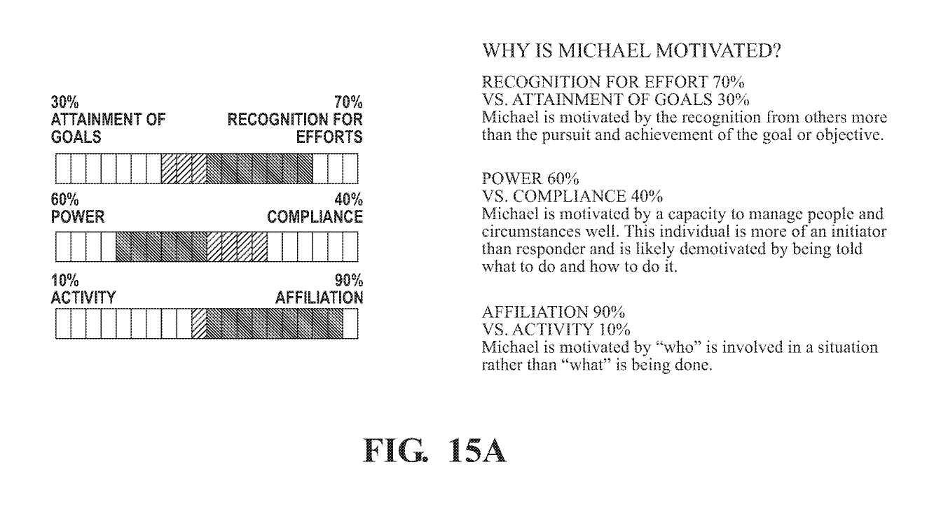

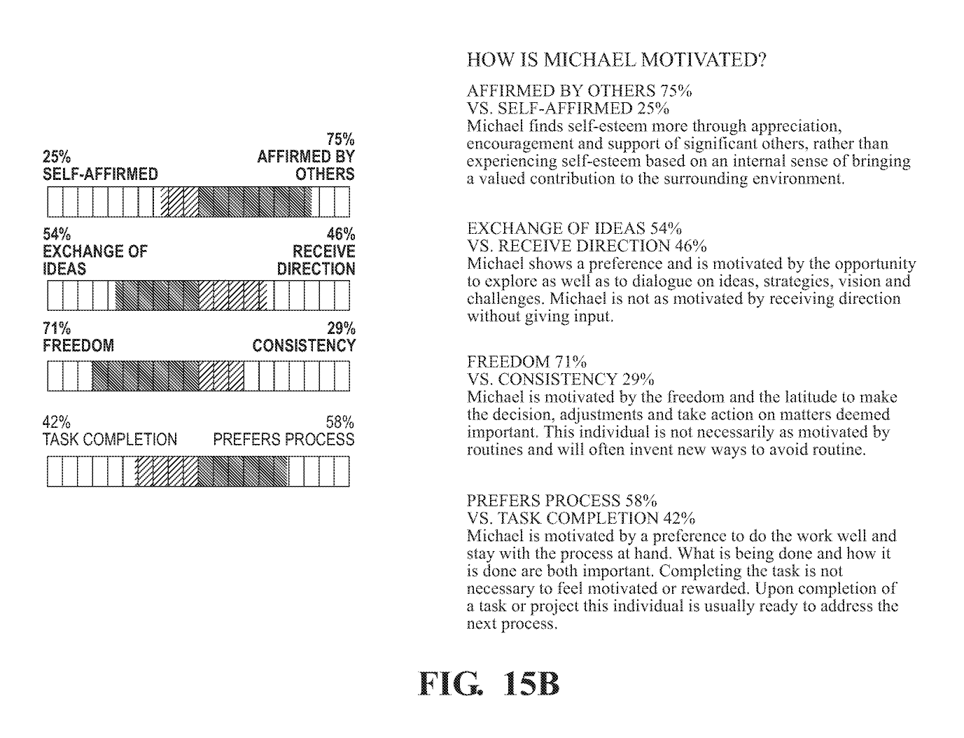

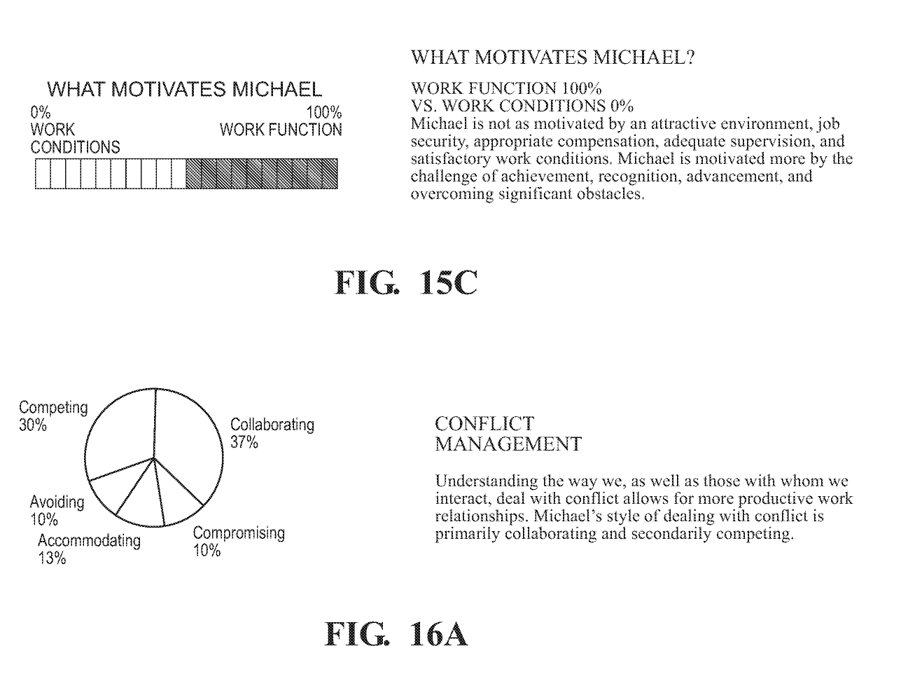

Motivation is also a determination of the PRISM™ 90 assessment, as shown in FIGS. 15A-15C. Some employees may want recognition while others need a little encouragement to keep moving forward. The motivation output of the PRISM™ 90 assessment uncovers how people are motivated, why they are motivated, and what they are motivated by.

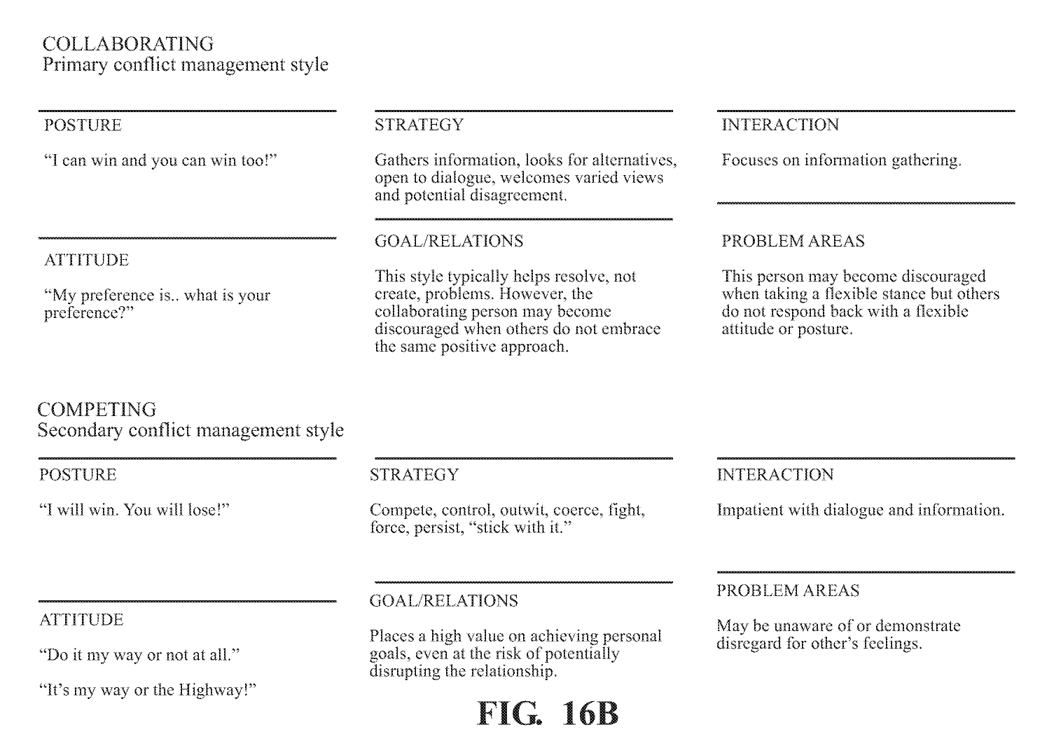

How employees deal with workplace conflicts is important since such conflicts arise all the time. The conflict management output of the PRISM™ 90 assessment, as shown in FIGS. 16A and 16B reveals how a business's employees or prospective employees work through issues with others, by competing, calibrating, avoiding, accommodating or compromising. Such insights allow business administrators greater understanding on how the business's employees interact with one another and deal with conflict, thereby allowing the business administrator to foster more productive working relationship.

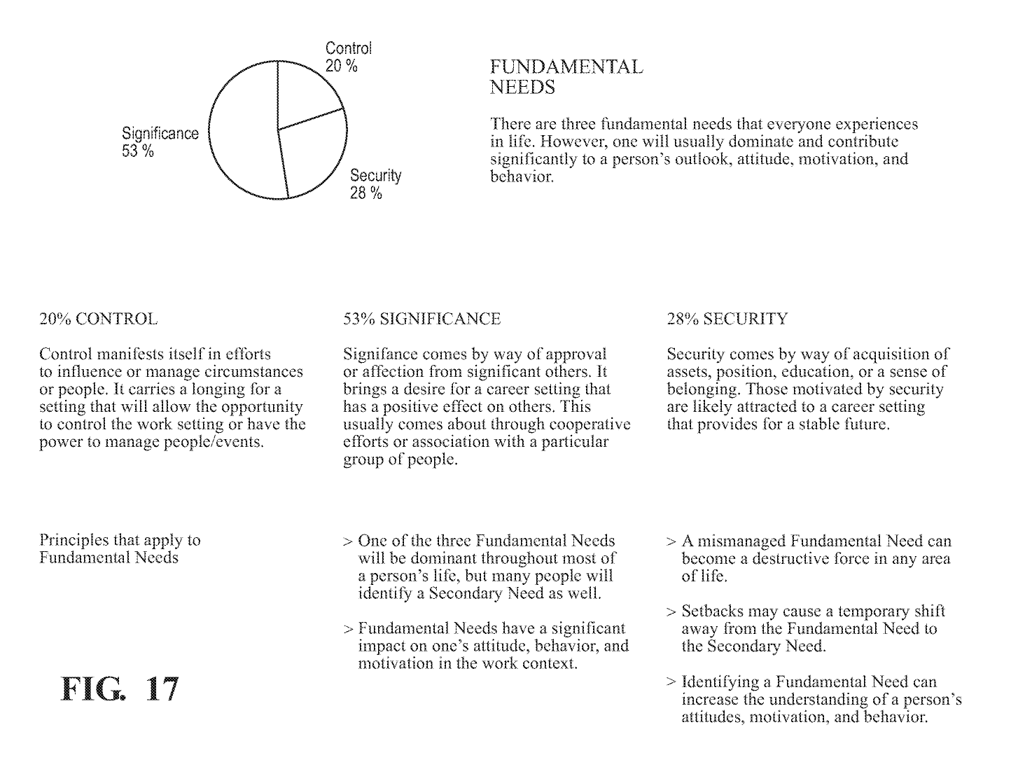

All employees have fundamental needs that drive the employees and contribute to their outlook, attitude, motivation, and behavior. The fundamental needs output of the PRISM™ 90 assessment, as shown in FIG. 17 measures a person's desire to maintain control, have security or achieve significance. These insights provide a business administrator with a deeper understanding about their employee's needs for helping team members to appreciate and communicate with each other.

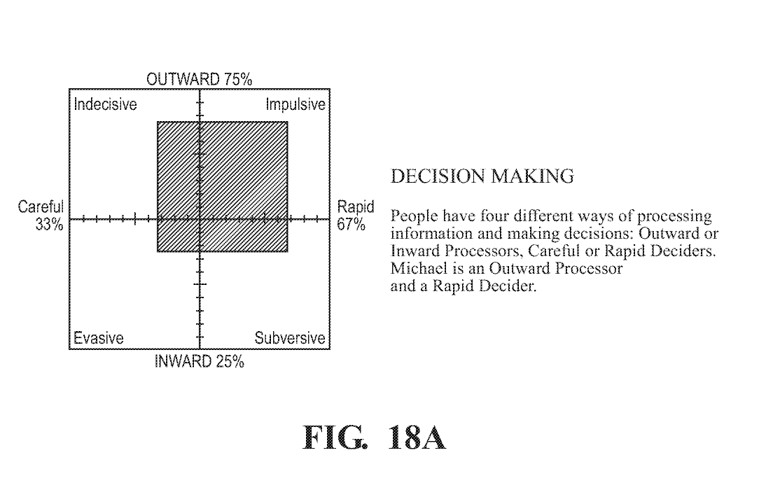

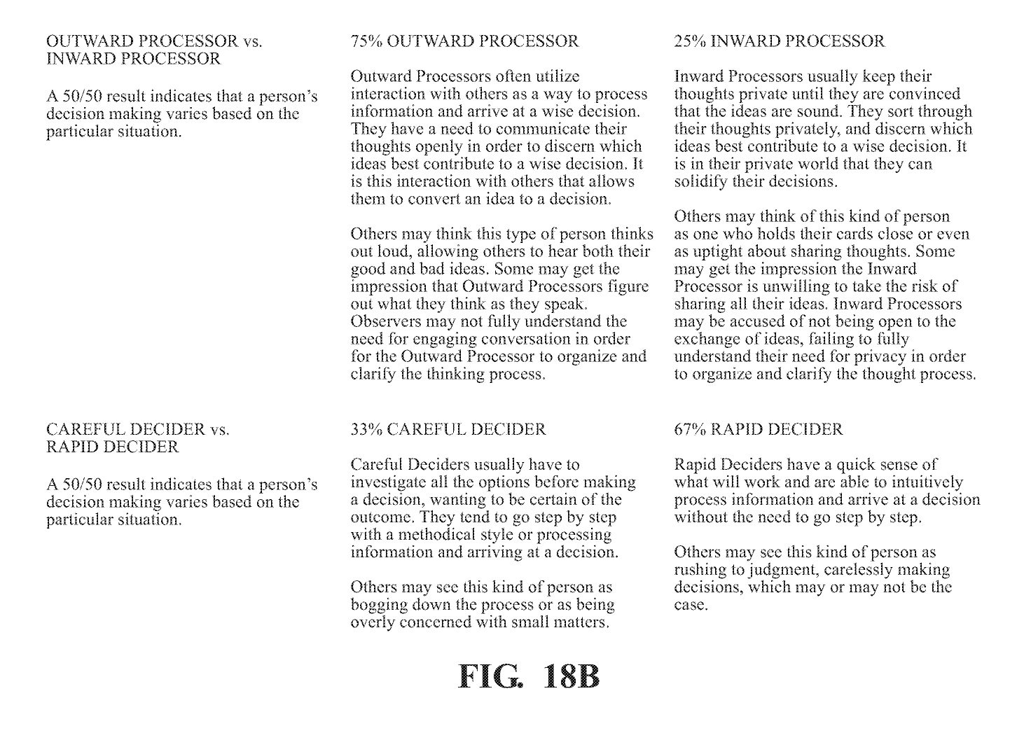

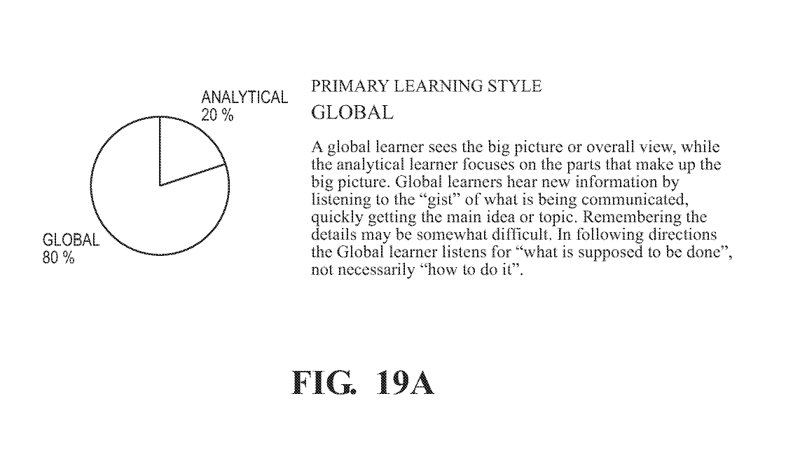

Every employee has their own unique style and internal or external rationale for making decisions. The decision making output of the PRISM™ 90 assessment, as shown in FIGS. 18A and 18B, measures this critical component of an individual based on four unique yet related decider scales, including outward, inward, careful and rapid.

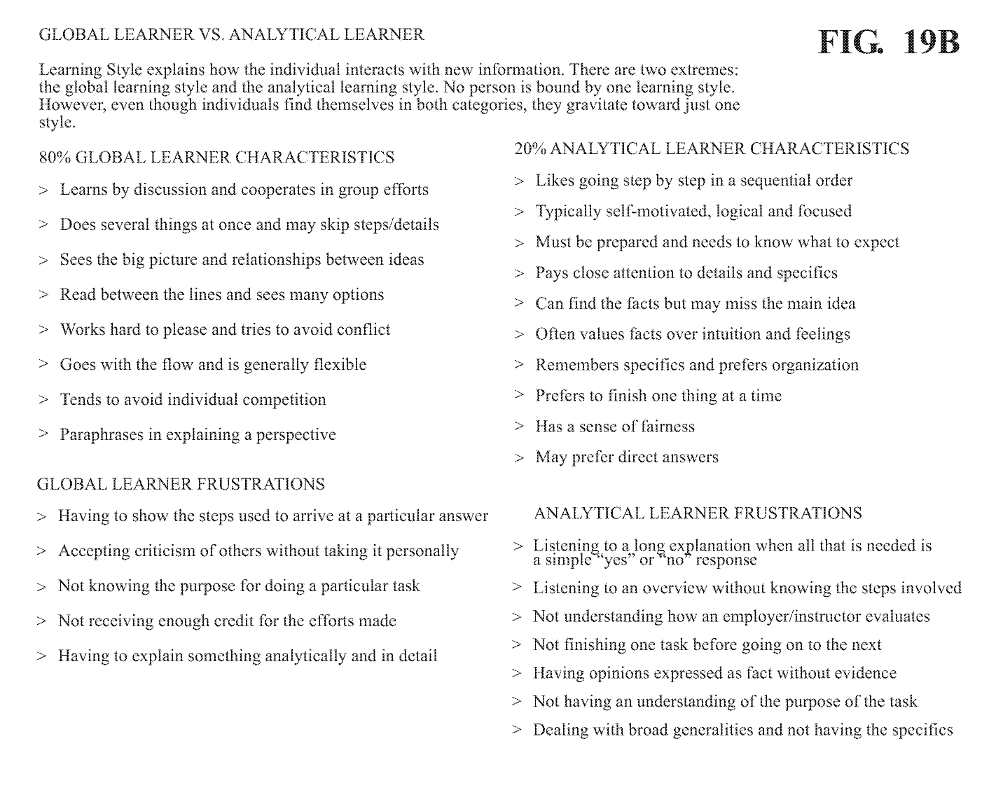

Understanding how people learn can assist a business and employees to communicate more effectively with one another in a team environment in another factor. The learning style output of the PRISM™ 90 assessment, FIG. 19A and 19B, reveals how people process information and details with two distinct scales of learning—global and analytical. A global leader tends to focus on the big picture and might take more risks than others. An analytical leader pays close attention to the details and strives for accuracy.

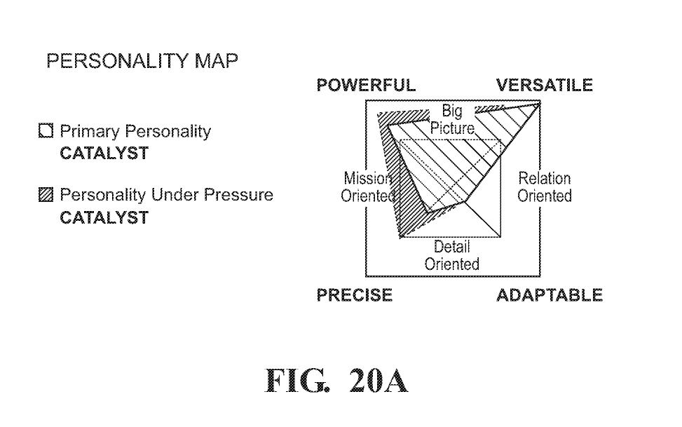

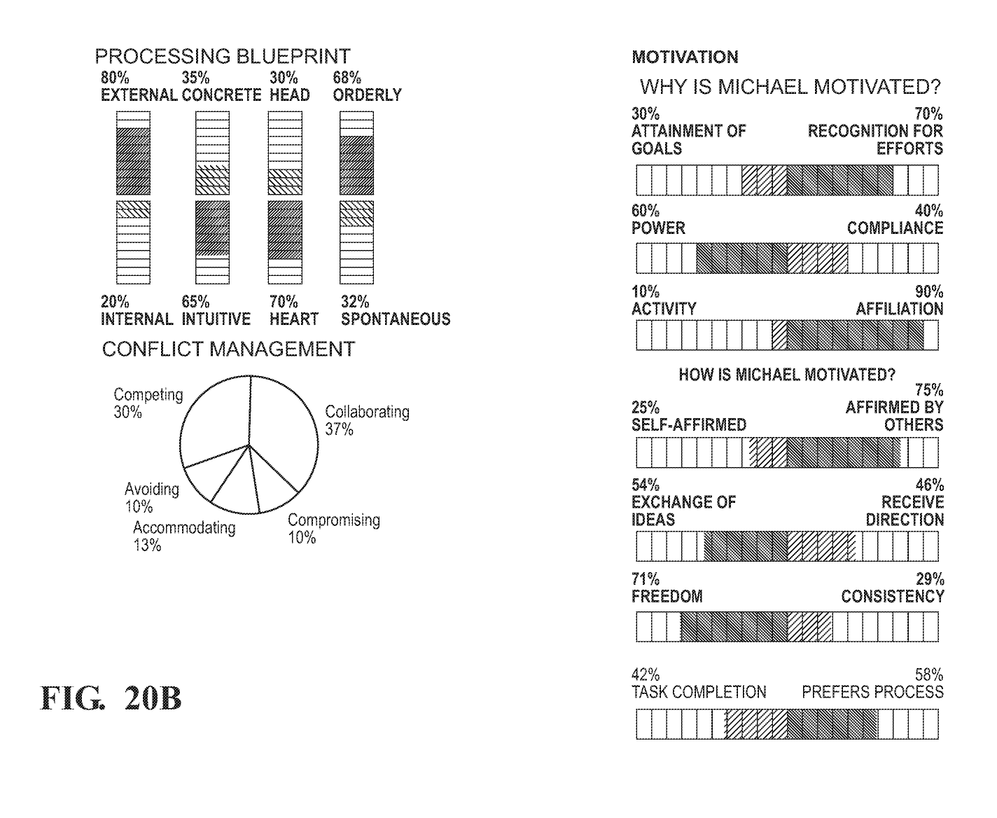

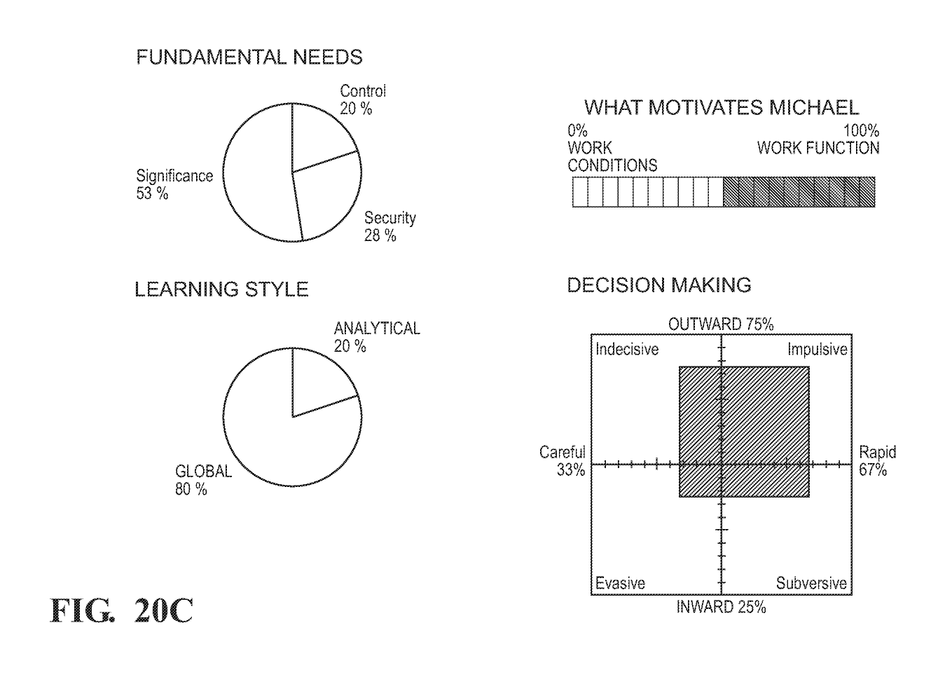

FIGS. 20A-20C depict all of the charts and graphs shown in FIGS. 12A-19B in a one-page summary for ease of use by a business administrator as well as the individual to determine the individuals' personality characteristics.

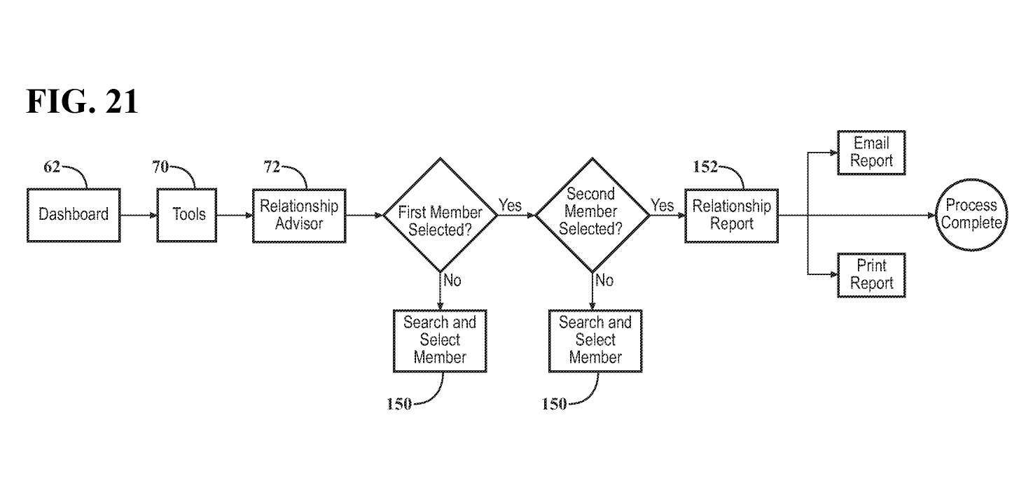

The relationship advisor module 72, shown in detail in FIG. 21, allows a business administrator to search and select one or more members in step 150 which review the prospective candidate profile and assessment results and prepare a relationship report 152.

The relationship advisor module 72 enables a manager to compare different individuals, recognize potential areas of conflict, and build positive inter-personal relationships with its employees. The relationship advisor module 72, based on the employee assessment data, alerts managers and employees to specific things to avoid or things to make an effort to do while working with each other. This enables administrators and employees to proactively prevent conflicts before they happen and reactively address issues when they arise.

In addition, or alternately, the present assessment apparatus and method provides a business administrator with the ability to select two individuals of a business team or who are working on the same project or in the same department, and compare their primary personality and their personality under pressure to determine the potential issues which may arise from the relationship of these two individuals as well as to provide prospective and insight for the business and manager in how to lead the individuals by making suggestions on how each individual can make an effort to or try to avoid certain personality features when dealing with the other individual.

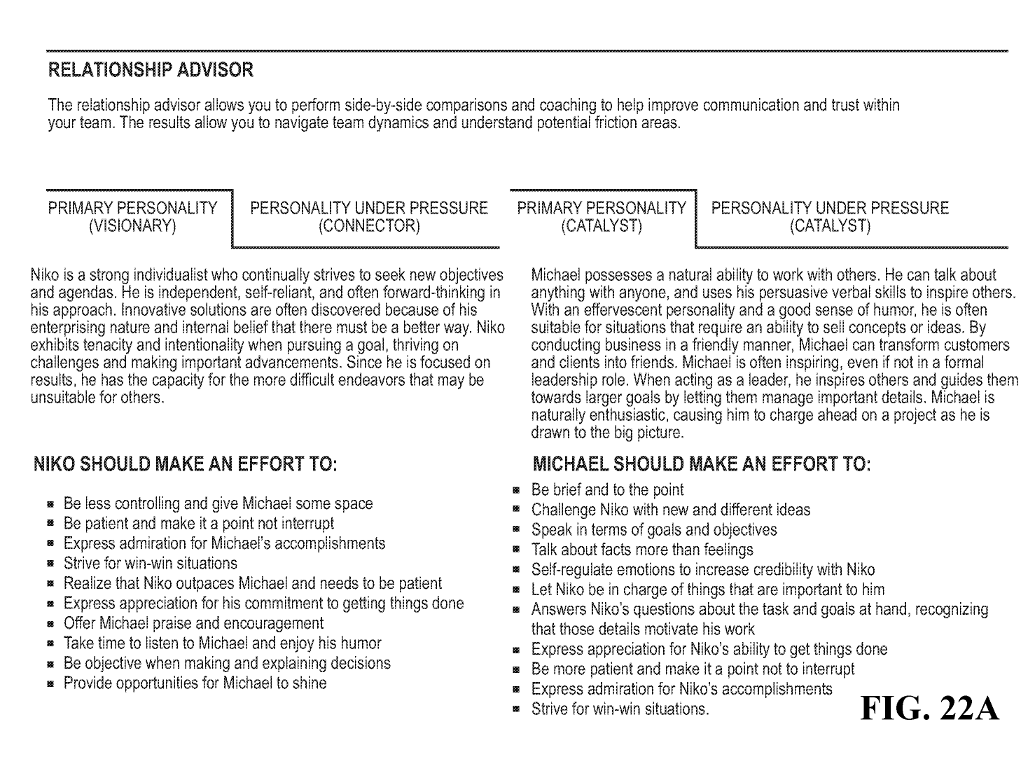

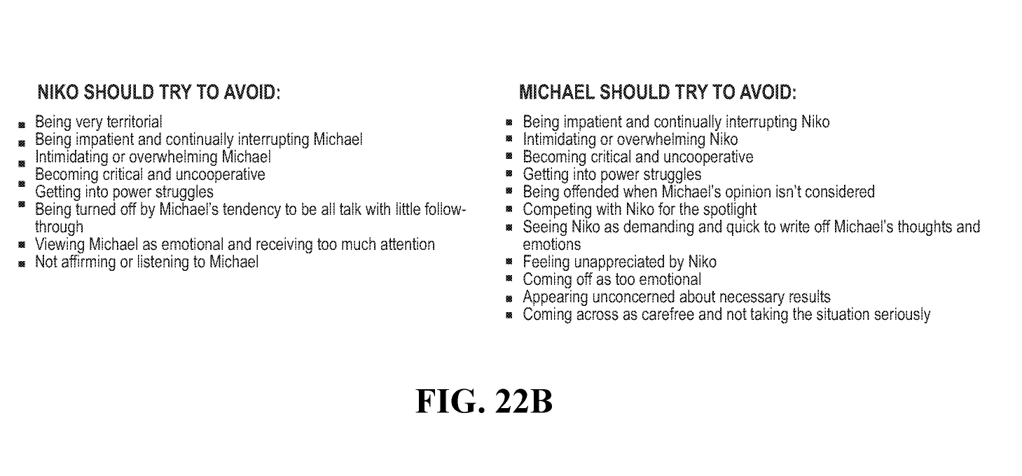

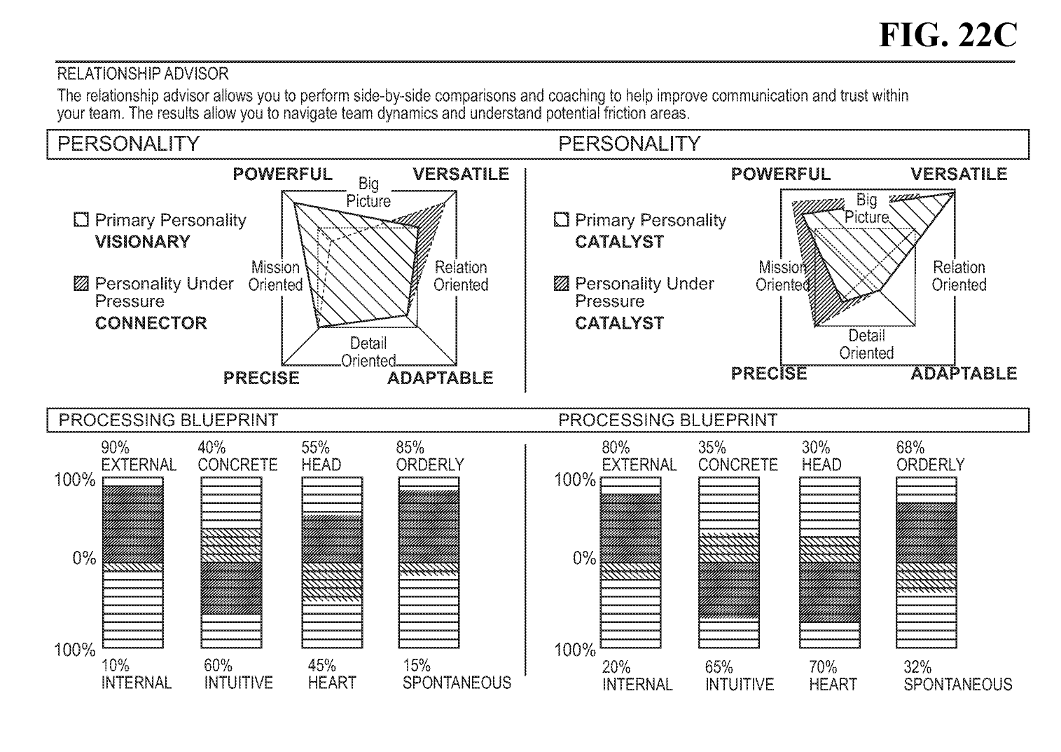

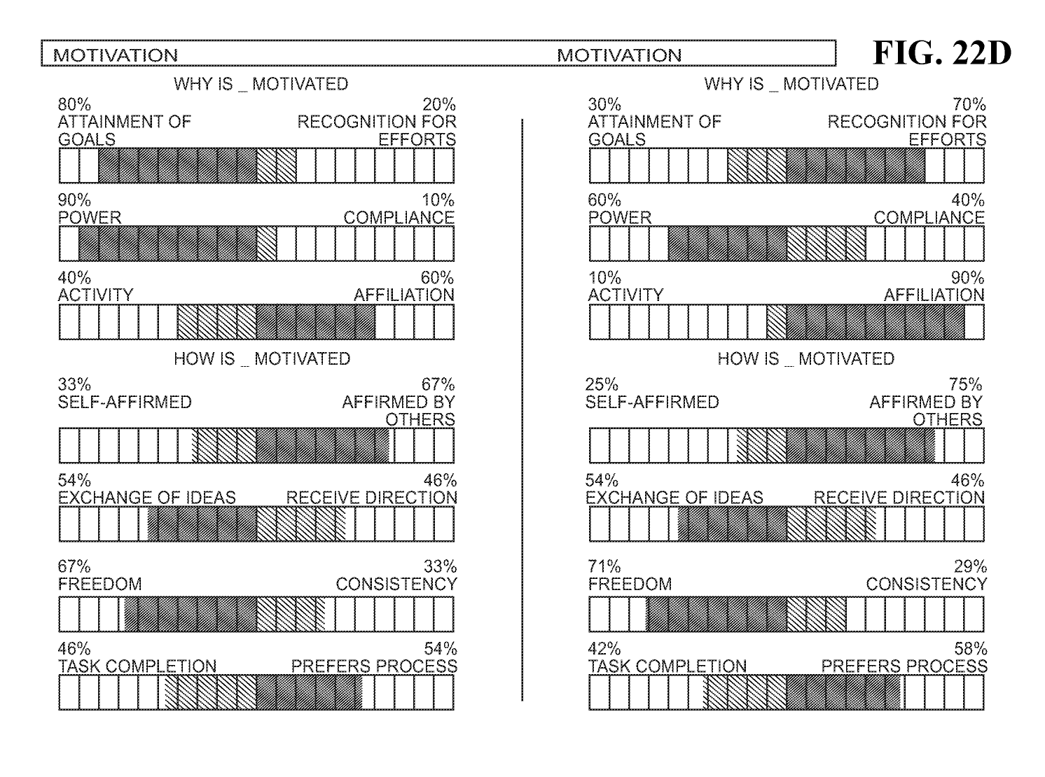

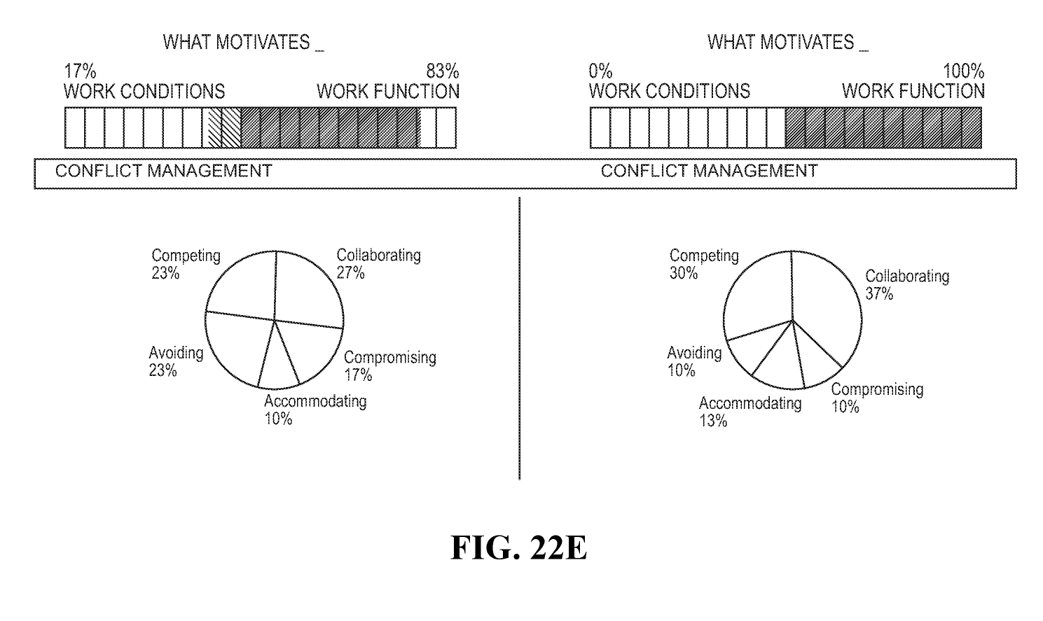

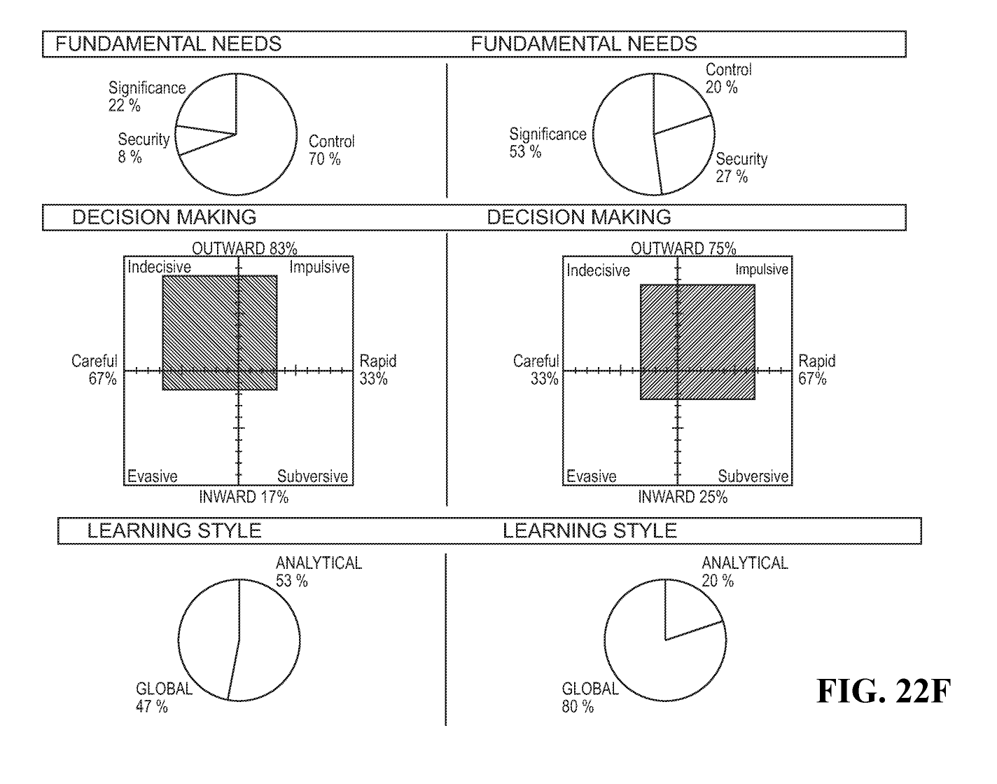

When the relationship advisor module 72 is selected in FIG. 3A, the business administrator can select two individuals, as shown in FIGS. 22A-22F take the PRISM™ 90 assessment or can review the previous assessment 90 results for the two selected individuals.

FIGS. 22A-22F show an example of a relationship advisor report displayed or otherwise generated for the business administrator comparing the personality assessment results and data of the two selected individuals. These personality characteristics data are provided for a plurality of assessments. As described above and shown in the previous drawing figures, any or all the seven personality profiles of the PRISM assessment 90 can be displayed, as shown in FIGS. 22C-22F, in a side by side arrangement to determine the differences and similarities of the selected different trait assessments.

### APPENDIX A

### Personality Profiles

Ally

Allies are calm, modest and always willing to accommodate others. They lead others and relate in a supportive and personal manner. Allies maintain a low profile by blending into work and social situations. They are reliable and work at a steady and predictable pace, keeping the peace and mediating among contentious people. They influence others with their accommodating nature, pleasant posture and consistent work performance. Allies are likely to lead by being helpful to those in the workplace who are considered friends. They achieve remarkable consistency in performance when there is an opportunity to specialize within a predictable environment. Expressed appreciation and affirmation from work associates go a long way in motivating them.

Ambassador

Ambassadors naturally network well with others and have the ability to talk about anything with anyone. Ambassadors approach life with a people come first philosophy. They are supportive and maintain relationships with diplomacy, personal warmth and understanding. They are likely to solve problems by listening, showing tolerance and offering suggestions. The Ambassador typically notices and encourages the strengths of others while maintaining long-term relationships; likewise, they respond well to encouragement from others.

Architect

Architects are precise, systematic workers and thinkers who tend to follow procedures both at work and in their personal lives. They have a soft side that shows their modesty and willingness to accommodate others. They are conscientious and thorough when performing work that requires attention to detail and accuracy. In fact, Ambassadors are exceptionally detail-oriented and typically discover information that others have a tendency to overlook. They also tend to prefer a predictable environment with specific expectations on how much time is involved and on what basis the work is likely to be evaluated. When it comes to decision-making, they are known to be objective and informed thinkers, taking the time to gather and analyze data instead of jumping to conclusions. They take calculated risks based on facts and are inclined to maintain high standards in their work environment.

Catalyst

Catalysts possess a natural ability to work with others. They can talk about anything with anyone, and use their persuasive verbal skills to inspire others. With an effervescent personality and a good sense of humor, they are often suitable for situations that require the ability to sell concepts or ideas. By conducting business in a friendly manner, Catalysts can transform customers and clients into friends. Catalysts are often inspiring, even if not in formal leadership roles. When acting as leaders, they inspire others and guide them towards larger goals by letting them manage important details. Catalysts are naturally enthusiastic, and charge ahead on projects as they are drawn to the big picture.

Connector

Building friendships in a variety of settings and maintaining an extensive network of contacts comes naturally to Connectors. They can be people magnets with the natural ability to attract others. Connectors lead with enthusiasm and desire while building a positive social environment in which maintaining contact with people is necessary. Because of the broad network they establish, they likely has access to people who can be very helpful in many different areas. Connectors possess the ability to promote ideas and inspire enthusiasm in others. They are usually optimistic and can form favorable conclusions without having all the details nailed down. This optimism allows them to embrace change and spontaneity.

Influencer

Influencers are critical thinkers who utilize effective verbal skills to inspire others to a cause. They possess an effervescent personality and a good sense of humor. Influencers are likely to display a natural interest in detailed strategies that help accomplish an established goal. They can communicate the desired big picture and help others visualize the necessary steps needed to accomplish the goal. As such, they can be incredibly persuasive when engaging others in a task or project. Influencers are ambitious and precisely detailed in their approach, while also being considerate in their relationships.

Instructor

Instructors have a desire to dramatically influence people as well as improve their surroundings. Whether through an assigned role or casual contact, they lead others by exerting an energetic personality. While leadership isn't always assigned, their ambition and goal-oriented vision makes them natural leaders. Instructors tend to focus on the big picture and are able to identify the motives of others while directing them toward a predetermined goal. In formal leadership roles, Instructors may inspire or persuade others while using their verbal skills to recruit others for a cause. People are often attracted to their social skills and confidence.

Navigator

Navigators can be both assertive and sensitive in their quest to achieve a desired outcome. They desire tangible results and implement sound, procedural methods to attain them. They are likely to implement practical changes and have the ability to plan considerably. They are naturally cautious, which proves beneficial when exploring and analyzing decisions. They also work well when given a certain measure of freedom to make decisions and lead.

Peacemaker

Peacemakers relate exceptionally well to others and are strong at networking. They strive to build a pleasant and productive work environment because their primary approach to life is based on relationships rather than tasks or objectives. Peacemakers typically notice the strengths of others and maintain long-term relationships. They leave a positive impression with their warmth, empathy and consideration. They are likely to solve problems by listening and offering suggestions in a diplomatic, supportive manner and are motivated by recognition for a job well done. When placed in a position of responsibility, Peacemakers excel at recognizing both the achievements of other group members and focusing on the quality of the work.

Pioneer

Pioneers possess a variety of strengths and are naturally ambitious. They generally have no problem assuming difficult challenges, strenuous tasks or competitive situations. Pioneers are assertive, enterprising and project self-confidence. They intentionally seek to take on opportunities that stretch and develop their abilities. If told that something cannot be done, Pioneers will likely respond with a can do attitude. Being objective and results-oriented, they may prefer to work alone to achieve the best results, but they also have the ability to persuade others to join them to accomplish a desired result. Pioneers can rise to the occasion and can take charge whenever necessary.

Pragmatist

Pragmatists can be serious and detailed-oriented, as well as fun loving and carefree. They possess a desire for critical thinking, making decisions and taking action based on detail, accuracy and correctness. They are outgoing and naturally enjoy being with people. Networking with others comes easily and they can often talk about anything with anyone. They are conversant in a broad range of subjects and project a relaxed and diplomatic style. Pragmatists tend to involve and engage others through persuasion. They typically desire to be proficient in their work and naturally gravitate toward a specialty area. Pragmatists can be counted on to be consistent and reliable because they hold high standards for personal performance with an emphasis on self-discipline.

Researcher

Researchers are objective and analytical. They will calmly and steadily pursue a path towards a fixed goal. They are likely to be successful due to their determination, organization and persistence to follow through on projects. Researchers desire tangible results while obtaining a high level of excellence. They strive to achieve defined agendas and objectives and tend to respond with logic more than emotions. Researchers shine when it comes to challenges that require the application of factual data and analysis to form a conclusion. Their strength of personality and desire to get things right leads them to have high personal standards and a prudently cautious approach to decision making.

Scientist

Scientists are exceptionally detail-oriented and analytical. They have a strong need to get things just right, as they remain highly focused on that goal. Scientists possess a natural desire to think critically and to act based on correctness, accuracy and well-researched facts. This approach has a strong impact on their decision making process. They seek accuracy and logic and will explore all possible options before arriving at a conclusive decision. Scientists have a very strong task-orientation and prefer a peaceful work environment. Their desire to be conscientious and principled is well intentioned and can positively impact the work environment.

Strategist

Strategists move both people and tasks in a forward direction because of their vision and social skills. They often possess the ability to identify the motives of others and then rally them toward a predetermined goal. Whether through formal responsibility or casual contact, Strategists lead others with energetic personalities and a plan. They are intentional, goal-oriented, and focused on the big picture. In formal leadership roles, Strategists inspire and persuade others. People are strongly attracted to their social skills and assertive personalities. Strategists are likely to use their verbal skills to recruit others for a cause. Hidden within their strong personality is a softer and more empathetic approach that causes them to be liked by work associates.

Tough & Tender

Tough & Tenders are often motivated by deeply felt convictions, objectives and goals. They are likely to possess a strong internal drive for accomplishment while applying the necessary pressure to attain desired results. When Tough & Tenders are confident that the job will be done right, they easily delegate tasks to those they trust. Their ambition indicates that they hold high personal standards, which translate well into their work. Tough & Tenders have a strong drive for achievement but can also be socially driven. They are supportive and possess a sensitive side that may not always be apparent.

Visionary

Visionaries are strong individualists who continually strive to seek new objectives and agendas. They are independent, self-reliant, and often forward thinking in their approaches. They often discover innovative solutions because of their enterprising nature and internal belief that there must be a better way. Visionaries exhibit tenacity and intentionality when pursuing a goal. They thrive on challenges when making important advancements. Since they focus on results, they have the capacity for more difficult endeavors that may be unsuitable for others.

1. A method generating an individual's assessment data comprising:
accessing memory by a computer processor coupled through a network to individual processors;
administering an assessment through at least one of the individual processors to determine an individual's assessment data;
analyzing the assessment data by the computer processor and generating an assessment report to the at least one of the individual processors containing assessments of the individual; and
generating relationship factors for at least one of two individuals relating to relationship factors that at least one of the two individuals should recognize when interacting with the other of the two individuals.

2. An apparatus for generating an individual relationship factors between two individuals based on assessment data comprising:
a computer processor assessing an assessment test;
at least one individual processor coupled through a network to the computer processor; and
a display coupled to the at least one individual processor for displaying relationship factors between the two individuals.
